(19) United States
(12) Patent Application Publication
(10) Pub. No.: US 2026/0221864 A1
(43) Pub. Date: Jul. 30, 2026

(54) A DC-DC MULTIPORT CONVERTER

(71) Applicants: Amirnaser Yazdani, Maple (CA); Sandeep Kaler, Brampton (CA)

(72) Inventors: Amirnaser Yazdani, Maple (CA); Sandeep Kaler, Brampton (CA)

(21) Appl. No.: 19/146,503

(22) PCT Filed: Jan. 8, 2024
(86) PCT No.: PCT/CA2024/050015

§ 371 Date: Jul. 8, 2025

Related U.S. Application Data
(60) Provisional application No. 63/437,828, filed on Jan. 9, 2023.

(51) Int. Cl. H02M 1/00; H02J 3/32; H02J 3/38; H02J 101/24; H02M 3/157

(52) U.S. Cl. CPC H02M 1/0085; H02J 3/32; H02J 3/381; H02M 3/157; H02J 2101/25

(57) ABSTRACT

A DC-DC multiport converter (MPC) is provided for transfer of power between an energy generation subsystem, an energy storage subsystem and a DC network. The MPC comprises a multi-winding transformer having a first transformer side and a second transformer side; a first MPC circuit branch and a second MPC circuit branch connected in parallel on the first transformer side to couple the DC link of the first transformer side with the energy generation subsystem and the energy storage subsystem; and a third MPC circuit branch and a fourth MPC circuit branch connected in parallel on the second transformer side to connect the DC link of the second transformer side with the DC network. The transfer of power is controlled when each of the submodules receive a submodule switching signal and each of the switching devices receive a switching device switching signal.

### CROSS-REFERENCE TO RELATED APPLICATION

This application claims the benefit of U.S. Provisional Patent Application No. 63/437,828 filed Jan. 9, 2023, and the entire contents of U.S. Provisional Patent Application No. 63/437,828 are hereby incorporated herein in its entirety.

### FIELD

Various embodiments are described herein that generally relate to DC-DC converters and in particular to DC-DC multiport converters for transfer of power between an energy generation subsystem, an energy storage subsystem and a DC network.

### BACKGROUND

The following paragraphs are provided by way of background to the present disclosure. They are not however an admission that anything discussed therein is prior art or part of the knowledge of a person of skill in the art.

The energy generation field is a significant contributor to global greenhouse gas emissions. However, energy generation equipment that can use renewable energy sources (e.g., solar energy, wind energy, geothermal energy, etc.) can help reduce global greenhouse gas emissions.

However, many renewable energy sources can have intermittent or variable operation and therefore do not provide a constant amount of energy. For example, solar energy may peak during mid-day and fall to zero at night. Other factors like cloud coverage and seasonal variations may also impact the amount of solar energy available. Energy storage devices are generally used in combination with the energy generation equipment to compensate for the variations in energy provided by the renewable energy source to a power grid. Accordingly, there is a need for electrical equipment that can be used to connect these various components and that can operate in an efficient and scalable manner.

### SUMMARY OF VARIOUS EMBODIMENTS

In accordance with an aspect, at least one embodiment is provided herein for a DC-DC multiport converter (MPC) for transfer of power between an energy generation subsystem, an energy storage subsystem and a DC network. The MPC comprises a multi-winding transformer having a first transformer side and a second transformer side; a first MPC circuit branch and a second MPC circuit branch connected in parallel on the first transformer side to couple the DC link of the first transformer side with the energy generation subsystem and the energy storage subsystem; and a third MPC circuit branch and a fourth MPC circuit branch connected in parallel on the second transformer side to connect the DC link of the second transformer side with the DC network. A DC link of the first transformer side is coupled with the energy generation subsystem and the energy storage subsystem. A DC link of the second transformer side is coupled to the DC network. Each of the first MPC circuit branch and the second MPC circuit branch have at least a pair of companion switching devices. Each of the third MPC circuit branch and the fourth MPC circuit branch have multiple series-connected submodules. The transfer of power is controlled when each of the submodules receive a submodule switching signal and each of the switching devices receive a switching device switching signal.

In at least one embodiment, a direction of power transfer between the first transformer side and the second transformer side is controlled by controlling a phase-shift ratio between the submodule switching signal and the switching device switching signal.

In at least one embodiment, the first MPC circuit branch includes a first switching device and a second switching device; the second MPC circuit branch includes a third switching device and a fourth switching device; and the switching device switching signal includes a first set of switching pulses to control switching of the first switching device, a second set of switching pulses to control switching of the second switching device, a third set of switching pulses to control switching of the third switching device, and a fourth set of switching pulses to control switching of the fourth switching device, wherein the second set of switching pulses are coordinated with the first set of switching pulses and the fourth set of switching pulses are coordinated with the third set of switching pulses.

In at least one embodiment, a duty ratio of the first set of switching pulses and the third set of switching pulses is selected to control a terminal voltage of the energy generation subsystem for implementing a maximum-power-point-tracking (MPPT) algorithm.

In at least one embodiment, the third MPC circuit branch includes a first arm and a second arm; the fourth MPC circuit branch includes a third arm and a fourth arm, wherein each of the first arm, the second arm, the third arm and the fourth arm includes multiple series-connected submodules; and the submodule switching signal includes a first set of switching pulses to control diagonally pairwise switching of the multiple series-connected submodules in the first arm and the fourth arm, and a second set of switching pulses to control diagonally pairwise switching of the multiple series-connected submodules in the second arm and the third arm.

In at least one embodiment, the multiple series-connected submodules in the first arm are switched by the first set of switching pulses in a coordinated sequence to generate a stepped trapezoidal arm voltage of the first arm.

In at least one embodiment, a second transformer side voltage is controlled by controlling a matching ratio between the first set of switching pulses and the second set of switching pulses.

In at least one embodiment, each of the switching devices include one or more semiconductor switching devices.

In at least one embodiment, at least one of the series connected submodules includes a half-bridge submodule topology, a full-bridge submodule topology, a clamp-double submodule topology, a three-level flying-capacitor (FC) submodule topology, a three-level neutral-point-clamped (NPC) submodule topology, or a five-level cross-connected submodule topology.

In at least one embodiment, the energy generation subsystem includes one or more photovoltaic (PV) arrays.

In at least one embodiment, the energy storage subsystem includes one or more batteries.

In at least one embodiment, the first transformer side is configured to operate in a low voltage range from about 0V to about 1.5 kV.

In at least one embodiment, the second transformer side is configured to operate in a medium voltage range from about 1.5 kV to about 30 kV.

In at least one embodiment, the center-tapped transformer side is configured to operate in a medium frequency range from about 1 kHz to about 100 kHz.

In at least one embodiment, the multi-winding transformer is a center-tapped transformer and a center-tap of the first transformer side is configured to be connected to a junction between the energy generation subsystem and the energy storage subsystem.

In accordance with another aspect, at least one embodiment is described herein for a DC-DC multiport converter (MPC) for transfer of power between an energy generation subsystem, an energy storage subsystem and a DC network. The MPC comprises a multi-winding transformer having a first transformer side and a second transformer side; a first MPC circuit branch and a second MPC circuit branch connected in parallel on the first transformer side to couple the DC link of the first transformer side with the energy generation subsystem and the energy storage subsystem; a third MPC circuit branch and a fourth MPC circuit branch connected in parallel on the second transformer side to connect the DC link of the second transformer side with the DC network; and a control system configured to control the transfer of power by providing a submodule switching signal to each of the submodules and a switching device switching signal to each of the switching devices. A DC link of the first transformer side is coupled with the energy generation subsystem and the energy storage subsystem. A DC link of the second transformer side is coupled to the DC network. Each of the first MPC circuit branch and the second MPC circuit branch have at least a pair of companion switching devices. Each of the third MPC circuit branch and the fourth MPC circuit branch have multiple series-connected submodules.

In at least one embodiment, the control system is further configured to control a direction of power transfer between the first transformer side and the second transformer side by controlling a phase-shift ratio between the submodule switching signal and the switching device switching signal.

In at least one embodiment, the control system is further configured to control a duty ratio of the first set of switching pulses and the third set of switching pulses to control a terminal voltage of the energy generation subsystem for implementing a maximum-power-point-tracking (MPPT) algorithm.

In at least one embodiment, the control system is further configured to control a second transformer side voltage by controlling a matching ratio between the first set of switching pulses and the second set of switching pulses.

In at least one embodiment, the multi-winding transformer is a center-tapped transformer and a center-tap of the first transformer side is configured to be connected to a junction between the energy generation subsystem and the energy storage subsystem.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1A shows a schematic diagram of a system that includes an AC-based network for transfer of energy between a renewable energy subsystem having one or more renewable energy generation devices and an AC grid.

FIG. 1B shows a schematic diagram of a system that includes a DC-based network for transfer of energy between a renewable energy subsystem having one or more renewable energy generation devices and an AC grid.

FIG. 1C shows a schematic diagram of another system that includes a DC-based network for transfer of energy between a renewable energy subsystem having one or more renewable energy generation devices and an AC grid.

FIG. 1D shows a schematic diagram of a system that includes a DC-based network for transfer of energy between a renewable energy subsystem having one or more renewable energy generation devices, an energy storage subsystem having one or more an energy storage devices, and a medium-voltage DC collection network.

FIG. 1E shows a schematic diagram of a system that includes a DC-DC multiport converter for transfer of energy between a renewable energy subsystem having one or more renewable energy generation devices, an energy storage subsystem having one or more energy storage devices, and a medium-voltage DC collection network, according to at least one example embodiment in accordance with the teachings provided herein.

FIG. 2 shows a schematic circuit diagram of an example embodiment of the DC-DC multiport converter of FIG. 1E in accordance with the teachings herein.

FIG. 3 shows an example equivalent circuit model of the DC-DC multiport converter of FIG. 1E.

FIG. 4A shows voltage waveforms of the DC-DC multiport converter of FIG. 1E corresponding to an example submodule switching signal and an example switching device switching signal.

FIG. 4B shows voltage waveforms of the DC-DC multiport converter of FIG. 1E corresponding to an additional example submodule switching signal and an additional example switching device switching signal.

FIG. 5 shows an example simplified equivalent circuit model for analysis of the switching control of the submodules of the second transformer side of the DC-DC multiport converter of FIG. 1E.

FIG. 6 shows a simplified circuit representation of the equivalent circuit model of FIG. 5.

FIG. 7 shows example switching pulse waveforms and voltage waveforms with reference to the equivalent circuit models of FIGS. 5 and 6.

FIG. 8A shows example switching pulse waveforms and voltage waveforms of the second transformer side (with reference to the equivalent circuit models of FIGS. 5 and 6) for implementation of a voltage matching scheme.

FIG. 8B shows additional example switching pulse waveforms and voltage waveforms of the second transformer side (with reference to the equivalent circuit models of FIGS. 5 and 6) for implementation of a voltage matching scheme.

FIG. 9 shows the relationship between the power throughput and voltage ratio of the DC-DC multiport converter of FIG. 1E for various operating points.

FIG. 10A shows example voltage waveforms (with reference to the equivalent circuit models of FIGS. 5 and 6) for implementation of a voltage matching scheme.

FIG. 10B shows additional example voltage waveforms (with reference to the equivalent circuit models of FIGS. 5 and 6) for implementation of a voltage matching scheme.

FIG. 11A shows example voltage waveforms (with reference to the equivalent circuit model of FIG. 3) corresponding to implementation of a voltage matching scheme and maximum-power-point-tracking (MPPT).

FIG. 11B shows a block diagram representation of an example embodiment of a method for generating a duty ratio and a matching ratio, in accordance with the teachings herein.

FIG. 12 shows an example graph of variation of the different components of power in the DC-DC multiport converter of FIG. 1E normalized to its maximum power throughput.

FIG. 13 shows additional example variations of the power throughput of the DC-DC multiport converter of FIG. 1E for various operating points.

FIG. 14 shows a flowchart of an example embodiment of a process for controlling transfer of power using the DC-DC multiport converter of FIG. 1E.

FIG. 15A shows a flow diagram representation of example modes of operation of the DC-DC multiport converter of FIG. 1E when an energy generation subsystem having one or more energy generation devices connected to the DC-DC multiport is generating power.

FIG. 15B shows a flow diagram representation of example modes of operation of the DC-DC multiport converter of FIG. 1E when an energy generation subsystem having one or more energy generation devices connected to the DC-DC multiport converter is not generating power.

FIG. 16 shows a schematic diagram illustrating an example embodiment of the hardware structure of a control system that may be used with the DC-DC multiport converter of FIG. 1E in accordance with the teachings herein.

FIG. 17 shows a schematic diagram of an example embodiment of a sorting algorithm used to regulate the submodule capacitor voltages on the second transformer side of the DC-DC multiport converter of FIG. 1E in accordance with the teachings herein.

Further aspects and features of the example embodiments described herein will appear from the following description taken together with the accompanying drawings.

### DETAILED DESCRIPTION OF THE EMBODIMENTS

The headings and Abstract of the Disclosure provided herein are for convenience only and do not interpret the scope or meaning of the embodiments.

Various embodiments in accordance with the teachings herein will be described below to provide an example of at least one embodiment of the claimed subject matter. No embodiment described herein limits any claimed subject matter. The claimed subject matter is not limited to devices, systems or methods having all of the features of any one of the devices, systems or methods described below or to features common to multiple or all of the devices, systems or methods described herein. It is possible that there may be a device, system or method described herein that is not an embodiment of any claimed subject matter. Any subject matter that is described herein that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling can have a mechanical or electrical connotation. For example, as used herein, the terms coupled or coupling can indicate that two elements or devices can be directly connected to one another or connected to one another through one or more intermediate elements or devices via an electrical signal, electrical connection, or a mechanical element, depending on the particular context.

Unless the context requires otherwise, throughout the specification and claims which follow, the word “comprise” and variations thereof, such as, “comprises” and “comprising” are to be construed in an open, inclusive sense, that is, as “including, but not limited to”.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any operable combination thereof. Accordingly, the term “any combination thereof” is meant to cover any operable combination of the elements which precede the phrase. For example, the phrase “A, B, C, D or any combination thereof” includes A; B; C; D; A and B; A and C; A and D; B and C; B and D; C and D; A, B and C; A, B and D; A, C and D; B, C and D as well as A, B, C and D assuming that all such combinations are operable (i.e., they can be used together in practice in a working embodiment).

It should be noted that terms of degree such as “substantially”, “about” and “approximately” as used herein mean a reasonable amount of deviation of the modified term such that the end result is not significantly changed. These terms of degree may also be construed as including a deviation of the modified term, such as by ±1%, ±2%, ±5% or ±10%, for example, if this deviation does not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as ±1%, ±2%, ±5%, or ±10%, for example.

Reference throughout this specification to “one embodiment”, “an embodiment”, “at least one embodiment” or “some embodiments” means that one or more particular features, structures, or characteristics may be combined in any suitable manner in one or more embodiments, unless otherwise specified to be not combinable or to be alternative options.

As used in this specification and the appended claims, the singular forms “a,” “an,” and “the” include plural referents unless the content clearly dictates otherwise. It should also be noted that the term “or” is generally employed in its broadest sense, that is, as meaning “and/or” unless the content clearly dictates otherwise.

In addition, at least a portion of the example embodiments of the systems, devices or methods described in accordance with the teachings herein may be implemented as a combination of hardware or software. For example, a portion of the embodiments described herein may be implemented, at least in part, by using one or more computer programs, executing on one or more programmable devices comprising at least one processing element, and at least one data storage element (including volatile and non-volatile memory). These devices may also have at least one input device (e.g., a keyboard, a mouse, a touchscreen, other input elements or any operable combination thereof) and at least one output device (e.g., a display screen, a printer, a wireless radio, other output elements or any operable combination thereof) depending on the type of device.

It should also be noted that some elements that are used to implement at least part of the embodiments described herein may be implemented via software that is written in a high-level procedural language such as object-oriented programming. The program code may be written in, for example, JAVA, PYTHON, C, C⁺⁺, Javascript, or in any other suitable programming language and may comprise modules or classes, as is known to those skilled in object-oriented programming. Alternatively, or in addition thereto, some of these elements implemented via software may be written in assembly language, machine language, or firmware as needed.

At least some of the software programs used to implement at least one of the embodiments described herein may be stored on a storage media or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions, such as program code, for one or more processors. The program code may be preinstalled and embedded during manufacture and/or may be later installed as an update for an already deployed computing system. The medium may be provided in various forms, including non-transitory forms such as, but not limited to, one or more diskettes, compact disks, DVD, tapes, chips, and magnetic, optical and electronic storage. In alternative embodiments, the medium may be transitory in nature such as, but not limited to, wire-line transmissions, satellite transmissions, internet transmissions (e.g., downloads), media, digital and analog signals, and the like. The computer useable instructions may also be in various formats, including compiled and non-compiled code.

Accordingly, any device described herein that executes software instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of the device or accessible or connectable thereto.

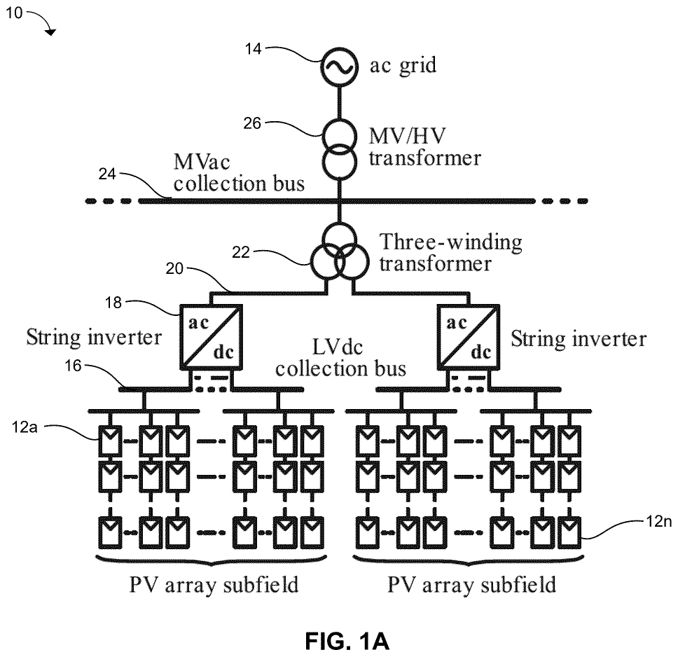

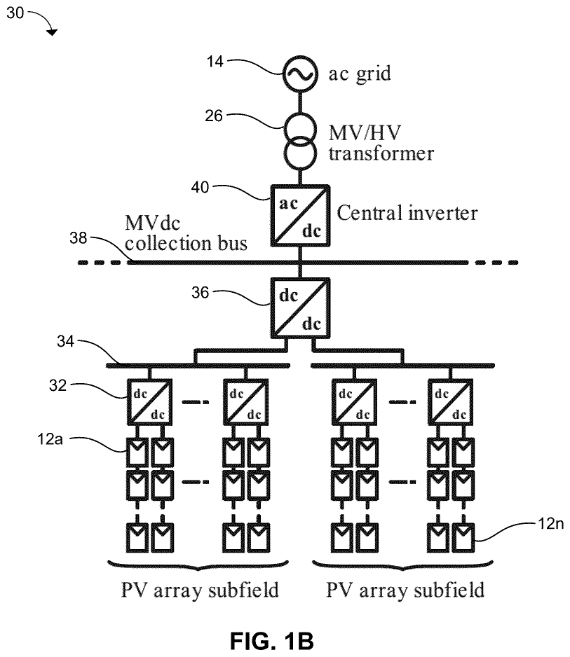

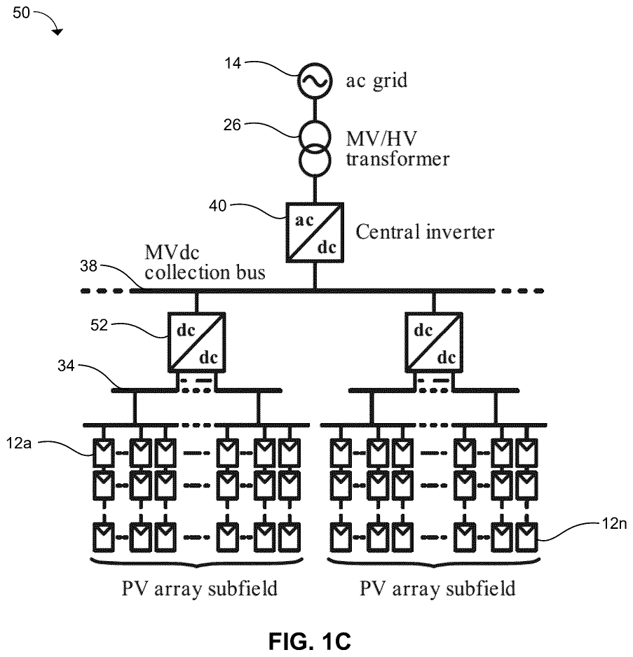

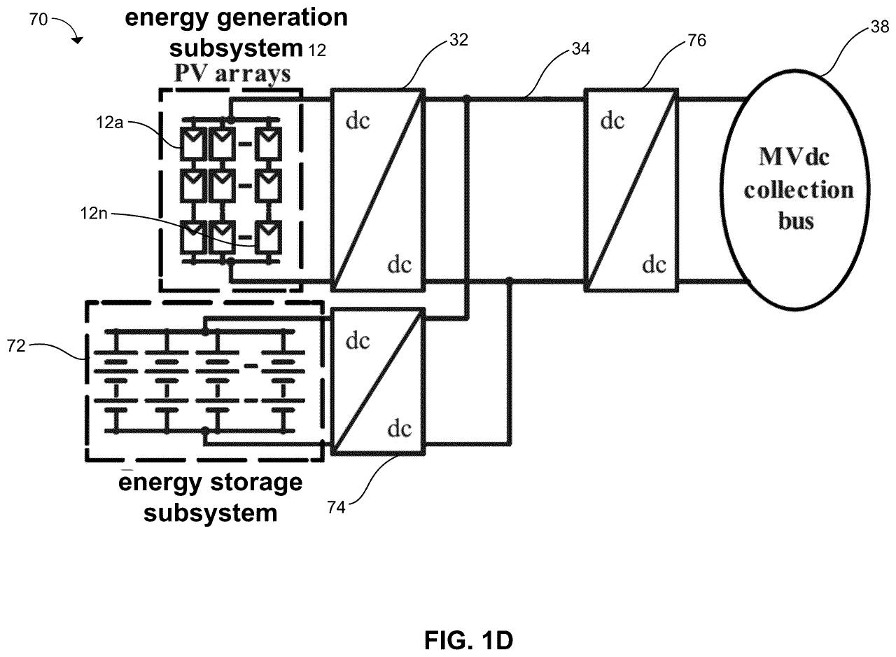

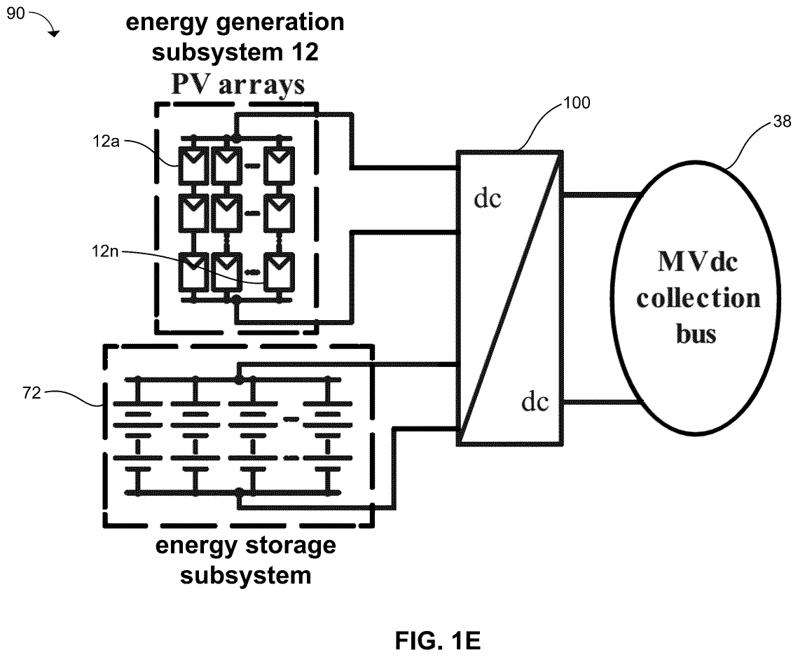

Referring first to FIG. 1A, shown therein is a schematic diagram of a system 10 that includes an AC-based network for transfer of energy between renewable energy generation devices 12a-12n (also collectively referred to as energy generation subsystem 12 herein) and an AC grid 14. The renewable energy generation devices 12a-12n may be connected to a low-voltage DC collection network 16. Multiple string inverters 18 may be used to change the low-voltage DC to low-voltage AC that can be connected to low-voltage AC collection network 20. A transformer 22 may be used to step up the low-voltage AC to medium-voltage AC that can be connected to medium-voltage AC collection network 24. A transformer 26 may be used to step up the medium-voltage AC to high-voltage AC that can be connected to AC grid 14.

Referring now to FIG. 1B, shown therein is a schematic diagram of a system 30 that includes a DC-based network for transfer of energy between renewable energy generation devices 12a-12n and an AC grid 14.

The renewable energy generation devices 12a-12n may be connected to a low-voltage DC collection network 34 using boost converters 32. The boost converters 32 may implement a maximum-power-point-tracking (MPPT) algorithm to optimize extraction of power generated by the renewable energy generation devices 12a-12n. The boost converters 32 may also boost the DC voltage of energy generation devices 12a-12n to a level that is suitable for the collecting converter 36.

The collecting converter 36 may act as an interface between the low-voltage DC collection network 34 and medium-voltage DC collection network 38. The collecting converter 36 may also include an isolated topology to provide electrical isolation of energy generation devices 12a-12n from the medium-voltage DC collection network 38.

In some applications, the DC collection network 38 may be configured to operate as an independent DC network that can function like a conventional electric utility grid but based on DC voltages and currents instead of AC voltages and currents. The DC collection network 38 may be connected to different elements including, but not limited to, DC loads (e.g., electric vehicles, data centers, LED lighting), energy storage devices (e.g., batteries) or additional renewable energy generation devices (e.g., devices similar to devices 12a-12n).

A central inverter 40 may act as an interface between the medium-voltage DC collection network 38 and the transformer 26. The transformer 26 may be used to step up the medium-voltage AC of central inverter 40 to high-voltage AC that can be connected to AC grid 14.

Referring now to FIG. 1C, shown therein is a schematic diagram of a system 50 that includes another DC-based network for transfer of energy between renewable energy generation devices 12a-12n and an AC grid 14.

The renewable energy generation devices 12a-12n may be connected to a low-voltage DC collection network 34. The DC converters 52 may provide the combined functionalities of boost converters 32 and collecting converters 36 shown in FIG. 1B. The DC converters 52 may implement a maximum-power-point-tracking (MPPT) algorithm to optimize extraction of power generated by the renewable energy generation devices 12a-12n and also step-up the low-voltage of energy generation devices 12a-12n to a medium-voltage that can be connected to medium-voltage DC collection network 38.

The central inverter 40 may act as an interface between the medium-voltage DC collection network 38 and the transformer 26. The transformer 26 may be used to step up the medium-voltage AC of central inverter 40 to high-voltage AC that can be connected to AC grid 14.

As described herein, an energy storage subsystem comprising one or more energy storage devices may be used in combination with renewable energy generation devices to compensate for variations in power generated by the renewable energy generation devices. Referring now to FIG. 1D, shown therein is a schematic diagram of a system 70 that includes a DC-based network for transfer of energy between a renewable energy subsystem comprising one or more renewable energy generation devices 12a-12n, an energy storage subsystem 72 which may include one or more batteries, and a medium-voltage DC collection network 38. The network configuration of system 70 may be similar to system 30 shown in FIG. 1B, except for the components related to the integration of the energy storage subsystem 72.

The renewable energy generation subsystem comprising renewable energy generation devices 12a-12n may be connected to a low-voltage DC collection network 34 using boost converters 32. The boost converters 32 may implement a maximum-power-point-tracking (MPPT) algorithm to optimize extraction of power generated by the renewable energy generation devices 12a-12n. The renewable energy generation devices 12a-12n may be implemented using PV arrays where each PV array is an energy generation device. The boost converters 32 may also boost the DC voltage of energy generation devices 12a-12n to a level that is suitable for collecting converter 76.

The boost converters 32 may be based on any suitable converter topology that is capable of providing a sufficient increase or “boost” to the input voltage, while being able to tolerate some amount of voltage variability at the input (due to the variation in the voltage provided by the renewable energy generation devices 12a-12n). In some cases, the boost converters 32 may be implemented to include additional elements such as the case in the isolated forward converter (single-ended or double-ended configuration) to provide isolation functionality in addition to the boosting functionality.

The collecting converter 76 may have any suitable configuration depending on the voltages of the low-voltage DC collection network 34 and the medium-voltage DC collection network 38. The collecting converter 76 may include a transformer to provide galvanic isolation between the low-voltage DC collection network 34 and the medium-voltage DC collection network 38. In some cases, the collecting converter 76 may be based on a modular converter configuration (e.g., the collecting converter 76 may be based on the “dual active bridge” converter configuration.

The energy storage devices of the battery energy storage subsystem 72 may be connected to the low-voltage DC collection network 34 using converter 74. The converter 74 and collecting converter 76 may be configured to process power in a bidirectional manner depending on whether the battery energy storage subsystem 72 is providing energy (discharging) or receiving energy (charging). In contrast, the boost converters 32 may only be required to process power in a unidirectional manner from energy generation devices 12a-12n to low-voltage DC collection network 34. In some cases, the converter 74 may be implemented based on the “dual active bridge” converter configuration or a suitable variation thereof.

The collecting converter 76 may act as an interface between the low-voltage DC collection network 34 and the medium-voltage DC collection network 38. The collecting converter 76 may also include an isolated topology to provide electrical isolation of energy generation devices 12a-12n (i.e., the energy generation subsystem) from the medium-voltage DC collection network 38. The medium-voltage DC collection network 38 may be connected to an AC grid (e.g., AC grid 14 as shown in FIG. 1B).

In one aspect, the embodiments disclosed herein generally relate to DC-DC multiport converters for transfer of power between an energy generation subsystem module, an energy storage subsystem and a DC network. The energy generation subsystem includes one or more energy generation devices such as but not limited to PV arrays and the energy storage subsystem includes one or more energy storage subsystem such as but not limited to one or more batteries.

In another aspect, the disclosed embodiments can provide galvanic/electrical isolation between the renewable energy generation devices and the medium-voltage DC collection network. The disclosed embodiments can also provide galvanic/electrical isolation between the energy storage devices and the medium-voltage DC collection network.

In another aspect, the disclosed embodiments may also enable implementation of MPPT algorithms to optimize extraction of power generated by the renewable energy generation devices.

In another aspect, disclosed embodiments may provide a modular and scalable design that can be easily modified to meet different system requirements.

Referring now to FIG. 1E, shown therein is a schematic diagram of a system 90 that includes a DC-DC multiport converter 100 (MPC 100) for transfer of energy between one or more renewable energy generation devices 12a-12n of energy generation subsystem 12, one or more energy storage devices of energy storage subsystem 72 and a medium-voltage DC collection network 38. The medium-voltage DC collection network 38 may be connected to an AC grid (e.g., AC grid 14 as explained herein above with reference to FIGS. 1B-1D).

Referring next to FIGS. 1A-1E together, MPC 100 may enable system 90 to solve one or more problems associated with systems 10, 30, 50 and 70. As a first example, system 10 may suffer from reactive power losses associated with AC networks 20 and 24. The reactive power losses may require electrical components to have higher electrical ratings than necessary. The reactive power losses may be substantially reduced in the DC-based network 30 because reactive power is only a major consideration in AC networks. This may be avoided by system 90 by being connectable to DC networks.

As a second example, the transformers 22 and 26 of system 10 may be line-frequency transformers (e.g., 50 Hz or 60 Hz depending on geographic location) that can be heavy, bulky and have large physical footprints. In contrast, the system 90 may not include any line-frequency transformers except at the point where the DC network is to be connected to an AC network. Furthermore, any transformers included in system 90 may operate at higher frequency compared with the line-frequency transformers and may therefore be substantially smaller, lighter and/or less expensive.

As a third example, MPC 100 of system 90 may provide a more efficient configuration compared with systems 30, 50 and 70. MPC 100 may use a new topology that provides the combined functionality of the boost converters and collecting converters of systems 30 and 70. This new topology can reduce the number of components, size, complexity and/or cost of the system by eliminating the requirement for separate boost converters and collecting converters. The new topology of the MPC 100 may also provide integration of one or more renewable energy generation devices of a renewable energy generation subsystem and one or more energy storage devices of an energy generation subsystem using a single DC-DC multiport converter. This can reduce the number of components, size, complexity and/or cost of the system compared with system 50 that may use separate unidirectional converters for connection of renewable energy generation devices and bidirectional converters for connection of energy storage devices.

As a fourth example, variations in the power produced by the renewable energy generation devices (e.g., due to variations in ambient conditions) may change the voltage ratio at the terminals of the collecting converter and thereby reduce the multiport converter efficiency. As described in further detail herein, the multiport converter 100 may enable system 90 to mitigate the negative impacts of the voltage ratio variations using a voltage matching scheme (VMS). The VMS may also enable reduction in the current stress on the circuit components, thereby simplifying the optimization process of the circuit components. In at least one embodiment, the VMS may allow for reduction of the component stress by up to 30%, and enable circuit design with lower-rated components.

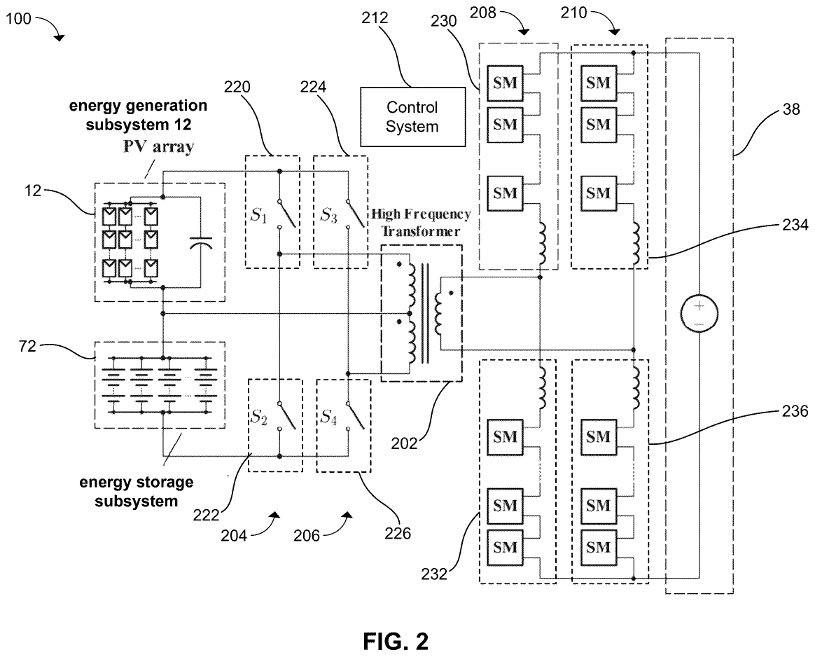

Referring now to FIG. 2, shown therein is a schematic circuit diagram of MPC 100. The MPC 100 may be used for transfer of power between energy generation subsystem 12, energy storage subsystem 72 and a medium-voltage DC collection network 38. For the example embodiment shown in FIG. 2, MPC 100 includes a multi-winding transformer 202, a first MPC circuit branch 204, a second MPC circuit branch 206, a third MPC circuit branch 208, a fourth MPC circuit branch 210 and a control system 212.

The multi-winding transformer 202 may have a first transformer side and a second transformer side. The multi-winding transformer 202 may have any suitable design to provide galvanic/electric isolation between the first transformer side and the second transformer side. In at least one embodiment, the multiple windings of the multi-winding transformer 202 may have an equal number of turns. Alternatively, in at least one embodiment, the multiple windings of the multi-winding transformer 202 may have an unequal number of turns.

In the example illustrated in FIG. 2, the multi-winding transformer 202 is a center-tapped transformer with a center-tap on the first transformer side. The center-tapped transformer may be implemented using two separate wire windings that are connected externally at the same point to form the center-tap. Alternatively, the wires may be wound in a bifilar manner to form the center-tap. The non-center-tapped second transformer side may be implemented using a single winding.

In at least one embodiment, the first transformer side may be configured to operate in a low voltage range. For example, the first transformer side may be configured to operate in a low voltage range from about 0V to about 1.5 kV. In other embodiments, the first transformer side may be configured to operate in a different voltage range (e.g., a medium voltage range from about 1.5 kV to about 30 kV, a high voltage range greater than about 30 kV).

In at least one embodiment, the second transformer side may be configured to operate in a medium voltage range. For example, the second transformer side may be configured to operate in a medium voltage range from about 1.5 kV to about 30 kV. In other embodiments, the second transformer side may be configured to operate in a different voltage range (e.g., a low voltage range from about 0 kV to about 1.5 kV, a high voltage range greater than about 30 kV.

In at least one embodiment, the multi-winding transformer 202 may be configured to operate in a medium frequency range. For example, the multi-winding transformer 202 may be configured to operate in a medium frequency range from about 1 kHz to about 50 kHz. In other embodiments, the multi-winding transformer 202 may be configured to operate in a different frequency range (e.g., a low frequency range less than about 1 kHz, a high frequency range greater than about 50 kHz).

A DC link of the first transformer side may be configured to be coupled with one or more energy generation devices of the energy generation subsystem 12 and/or one or more energy storage devices of the energy storage subsystem 72. For the example embodiment shown in FIG. 2, the DC link of the first transformer side is coupled with energy generation subsystem 12 and energy storage subsystem 72. A center-tap of the first transformer side may be connected to a junction between the energy generation subsystem 12 and the energy storage subsystem 72.

The energy generation subsystem 12 may include one or more renewable energy generation devices. For example, an energy generation device may include a photovoltaic (PV) array having multiple PV cells. As another example, an energy generation device may be a multiple wind turbine and the energy generation subsystem 12 may include one or more wind turbines. In other embodiments, energy generation devices may be other devices that capture renewable energy and can be coupled to MPC 100 as a DC element.

The energy storage subsystem 72 may have one or more energy storage devices and can have any suitable design to store electrical energy and supply the stored energy when required. For example, the one or more energy storage devices may be implemented using one or more batteries. The batteries may be charged using energy generated by the energy generation device 12 or energy provided by the DC network 38. The batteries may discharge and provide the stored energy when the energy generated by the energy generation device 12 is insufficient to meet demand from DC network 38. In other examples, the energy storage device can be any suitable device that can store electrical energy and can be coupled to MPC 100 as a DC element.

A DC link of the second transformer side may be configured to be connected to a DC network. For the example embodiment shown in FIG. 2, the DC link of the second transformer side is connected to medium-voltage DC collection network 38.

The first MPC circuit branch 204 and the second MPC circuit branch 206 may be connected in parallel on the first transformer side to couple the DC link of the first transformer side with the energy generation subsystem 12 and energy storage subsystem 72. The first MPC circuit branch 204 may have a pair of companion switching devices 220 and 222 (represented as S1 and S2 respectively in the schematic diagram). The second MPC circuit branch 206 may have a pair of companion switching devices 224 and 226 (represented as S3 and S4 respectively in the schematic diagram).

In at least one embodiment, each of the switching devices 220, 222, 224 and 226 may be semiconductor switches (e.g., MOSFETs). The switching devices 220, 222, 224 and 226 may enable a relatively simple design of MPC 100 because the first transformer side only requires four switching devices. As further described herein, the switching devices 220, 222, 224 and 226 may be switched in a diagonally-pairwise manner to enable zero-voltage switching operation for MPC 100.

The switching devices 220, 222, 224 and 226 may have any suitable design based on the operating voltage levels of MPC 100. For example, the switching devices may be MOSFET devices whose material composition may be selected based on the operating voltage levels and operating frequency. For instance, standard silicon MOSFETs may be used for operating voltage levels up to about 600V, but may not be used for high operating frequency ranges. As another example, Gallium Nitride MOSFETS may be used for operating voltages up to about 600V, but at a higher operating frequency range (100s of kHz) compared with the standard silicon MOSFETs. In another example, Silicon carbide MOSFETs may be used for operating voltages up to about 3.3 kV and may operate at frequencies up to about 100 kHz.

The switching devices 220, 222, 224 and 226 may be switched at high frequencies (e.g., frequencies greater than about 50 kHz) thereby enabling high operation frequencies of MPC 100. The high operation frequencies may enable reduced size and cost of the passive components of MPC 100. The frequency of operation may be selected based on the availability of passive components, such as the arm inductors, transformer cores, capacitors, etc. for the designed voltage, current, and power ratings. The selected switching frequency may be limited by a requirement to balance the benefit of reduced component size against increased switching losses. For example, an increase in switching frequency can reduce the size of most passive components but also result in an increase in the switching losses.

The third MPC circuit branch 208 and the fourth MPC circuit branch 210 may be connected in parallel on the second transformer side to connect the DC link of the second transformer side with the DC network 38. The third MPC circuit branch 208 may include a first arm 230 and a second arm 232. Each of first arm 230 and second arm 232 may include multiple series-connected submodules (SM). The fourth MPC circuit branch 210 may include a third arm 234 and a fourth arm 236. Each of third arm 234 and fourth arm 236 may include multiple series-connected submodules. In at least one embodiment, each of the multiple series-connected submodules may include a half-bridge submodule topology. In at least one embodiment, at least one of the multiple series-connected submodules may include any other submodule topology as is known by a person skilled in the art. For example, at least one of the multiple series-connected submodules may include a full-bridge submodule topology, a clamp-double submodule topology, a three-level flying-capacitor (FC) submodule topology, a three-level neutral-point-clamped (NPC) submodule topology, or a five-level cross-connected submodule topology.

The use of the series-connected submodules in the first arm 230, second arm 232, third arm 234 and fourth arm 236 may enable a relatively simple and modular design for MPC 100 where the number of submodules can be selected based on system requirements. Each submodule may include identical subcircuits that can reduce manufacturing complexity and easily replaced upon failure. Additionally, the addition of redundant submodules may increase the reliability of MPC 100. Furthermore, each of the submodules may be subject to a fraction of the total voltage thereby reducing size and cost of the submodule components.

The number of series-connected submodules may be selected based on the voltage level of the medium-voltage DC collection network 38, the component ratings of the switches, and the specifications of the submodules. For example, if MPC 100 is connected to a 20 kV dc network, and switches rated for 2 kV are selected, each submodule can tolerate 2 kV, and the number of series-connected submodules can be 10. A higher number of series-connected submodules may be needed if lower-rated switches (that may reduce the total cost of the MPC 100) are selected. The submodules may be based on the standard half-bridge converter configuration that includes two MOSFETs and one capacitor.

Control system 212 may have any suitable design to control the transfer of power between energy generation subsystem 12, energy storage subsystem 72 and medium-voltage DC collection network 38. Control system 212 may control the transfer of power by generating a submodule switching signal and a switching device switching signal. Control system 212 may provide the submodule switching signal to each of the series-connected submodules in the first arm 230, second arm 232, third arm 234 and fourth arm 236. Control system 212 may provide the switching device switching device signal to each of the switching devices 220, 222, 224 and 226.

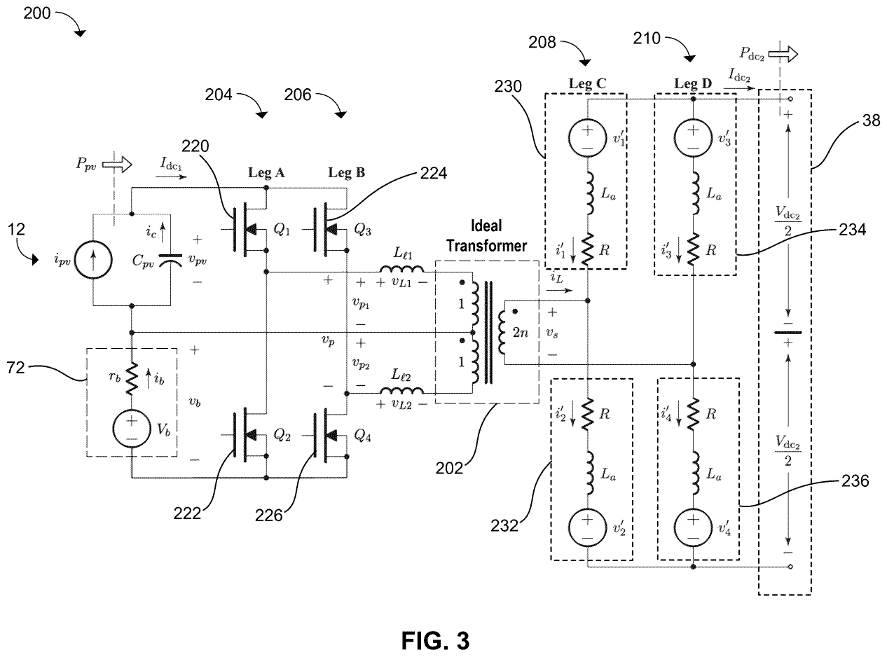

Referring now to FIG. 3, shown therein is an example equivalent circuit model 200 of MPC 100. The first MPC circuit branch 204, second MPC circuit branch 206, third MPC circuit branch 208, and fourth MPC circuit branch 210 may be labelled as Leg A, Leg B, Leg C, and Leg D respectively.

The current of the dc link of the first transformer side may be denoted as I_{dc1} and the current of the dc link of the second transformer side may be denoted as I_{dc2}. The voltage of the dc link of the second transformer side may be denoted as V_{dc2}.

The energy generation subsystem 12 may be represented by an ideal current source whose current is denoted by iₚᵥ, and the capacitor Cₚᵥ having a voltage vₚᵥ and connected across the ideal current source. The current of the capacitor may be denoted as i_{c}.

The energy storage subsystem 72 may be represented by a DC voltage source V_{b} and the internal resistance of the energy storage subsystem 72 may be represented by r_{b}. The sum of the voltages across the DC voltage source and the internal resistance may be represented as v_{b}. The dc link voltage for the first transformer side can be the sum of v_{b} and vₚᵥ.

The switching devices 220, 222, 224, and 226 may be represented as transistors Q₁, Q₂, Q₃, and Q₄ respectively. Q₁ and Q₂ may form a complementary pair in Leg A. Q₃ and Q₄ may form a complementary pair in Leg B. The voltages between the midpoints of Leg A and Leg B with respect to the center-tap of the transformer 202 may be denoted as vₚ₁ and vₚ₂ respectively, and the sum of these two voltages may be denoted as vₚ.

The multi-winding transformer 202 may be modelled by two leakage inductances L_{I1} and L_{I2} connected to an ideal center-tapped transformer. The multi-winding transformer 202 may have a 1:n turns-ratio overall, meaning that each winding on the first transformer side may have a 1:2n turns-ratio, and the current of the transformer may be referred to the second transformer side and denoted as i_{L}.

On the second transformer side, the transformer terminal voltage may be denoted as vₛ. The multiple series-connected submodules in each of the arms 230, 232, 234, and 236 may be represented as an arm voltage source in each of the arms and denoted following the same numbering sequence as the first transformer side. The arm inductance of each arm may be denoted as Lₐ. The copper losses and the on-state resistance of the series-connected submodules may be lumped together and modelled by a resistor R in each arm.

In at least one embodiment, MPC 100 may be configured to implement MPPT algorithms to extract the maximum power being generated at any given moment by the energy generation device. For implementing the MPPT algorithms, the terminal voltage of the energy generation device may need to be constantly adjusted such that MPC 100 tracks the maximum-power-point of the energy generation device. The following analysis can demonstrate MPC 100 implementing MPPT algorithms despite variations in voltage of the energy storage device.

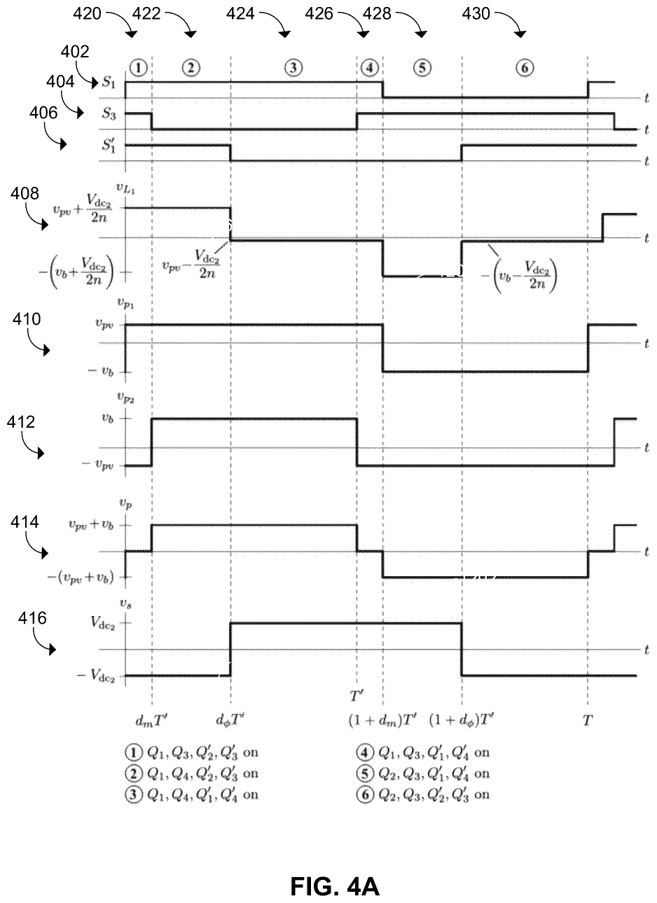

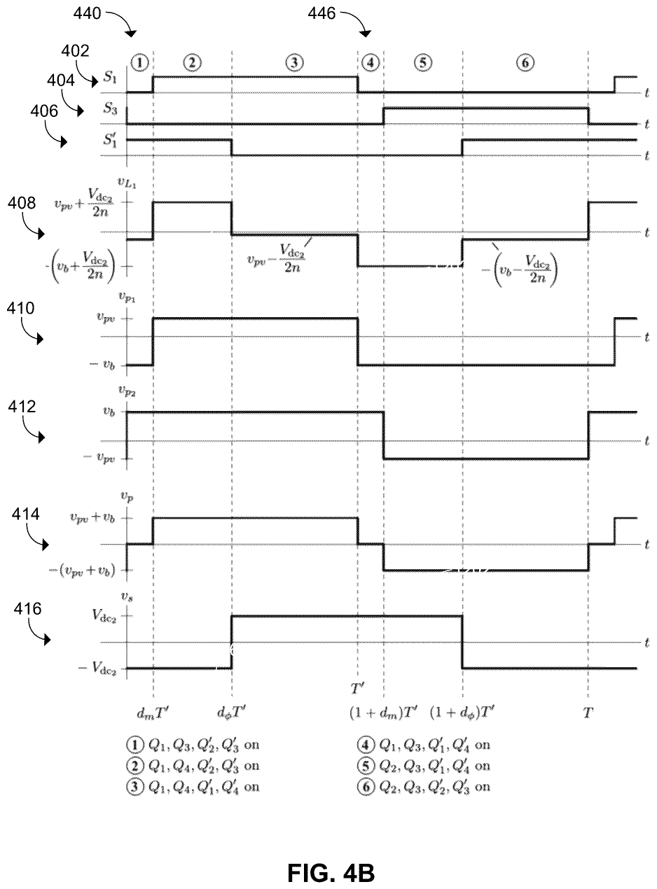

Reference is now made to FIGS. 4A and 4B. FIG. 4A shows voltage waveforms over one switching period T corresponding to an example submodule switching signal and an example switching device switching signal using the equivalent circuit model 200 (shown in FIG. 3) for MPC 100. FIG. 4B shows voltage waveforms over one switching period T corresponding to an additional example submodule switching signal and an additional example switching device switching signal using the equivalent circuit model 200 (shown in FIG. 3) for MPC 100.

For the following analysis, it is assumed that the quasi two-level (Q2L) modulation of the submodules and the VMS (described in detail herein below) are not implemented on the second transformer side. The submodules in each of arms 230, 232, 234, and 236 may therefore each be treated as a single switch, referred to as Q₁′-Q₄′ respectively. Accordingly, the voltage waveform 416 (denoted as vₛ) may be a two-level square wave with an amplitude of V_{dc2}. Additionally, the resistive losses of MPC 100 are neglected to simplify the following analysis.

The switching device switching signal may include a first set of switching pulses 402 (denoted as S₁) to control switching of switching device 220. Control system 212 may provide the first set of switching pulses 402 to switching device 220. The switching device switching signal may also include a second set of switching pulses that is coordinated with the first set of switching pulses 402. For example, coordinated may mean that the second set of switching pulses may be a logical inverse of the first set of switching pulses 402. It should be noted that in other embodiments, there may be other switching schemes that we may want to use to achieve certain objectives. Control system 212 may provide the second set of switching pulses to switching device 222.

The switching device switching signal may further include a third set of switching pulses 404 (denoted as S3) to control switching of switching device 224. Control system 212 may provide the third set of switching pulses 404 to switching device 224. The switching device switching signal may also include a fourth set of switching pulses that is coordinated with the third set of switching pulses 404. For example, coordinated may mean that the fourth set of switching pulses may be a logical inverse of the third set of switching pulses 404. Control system 212 may provide the fourth set of switching pulses to switching device 226.

The submodule switching signal may include a first set of switching pulses 406 (denoted as S₁′) to enable diagonally pairwise switching of first arm 230 and fourth arm 236. Control system 212 may provide the first set of switching pulses 406 to submodules of first arm 230 and fourth arm 236. Accordingly, the submodules of first arm 230 and fourth arm 236 may be switched by the same set of switching pulses 406. The submodule switching signal may also include a second set of switching pulses, to enable diagonally pairwise switching of second arm 232 and third arm 234, that is a logical inverse of the first set of switching pulses 406. Control system 212 may provide the second set of switching pulses to submodules of second arm 232 and third arm 234. Accordingly, the submodules of second arm 232 and third arm 234 may be switched by the same set of switching pulses (that is a logical inverse of the set of switching pulses 406). For this example, S₁′ being high indicates an inserted arm on the second transformer side.

As shown in FIG. 4A, the total period T can be broken down into six different intervals 420, 422, 424, 426, 428, and 430. Unlike the second transformer side, the first transformer side may operate such that voltage waveform 414 (denoted as vₚ) is a three-level waveform. The duration for which vₚ is equal to zero can be seen in interval 420 and interval 426, and may be defined as dₘT′, where dₘ is a dimensionless parameter that may be used to define the zero-state, and T′ is half of the switching cycle. Dₘ is a positive number for the example waveforms shown in FIG. 4A and dₘ is a negative number for the example waveforms shown in FIG. 4B. By analyzing the waveforms for the entire switching period, a relationship between the voltage v_{b} and vₚᵥ can be developed to facilitate MPPT by controlling the zero-state through dₘ.

The total period T shown in FIG. 4B can also be broken down into six different intervals. However, in contrast to FIG. 4A, there may be no overlapping time interval during which both S₁ and S₃ are high. For example, S₁ and S₃ are both high during time intervals 420 and 426 shown in FIG. 4A; while S₁ and S₃ are both zero during time intervals 440 and 446 shown in FIG. 4B.

In interval 420, switches Q₁ and Q₃ may both be conducting, meaning L_{I1} can be connected to the positive dc rail of the first transformer side. The voltage of L_{I1} can be written as:

$${v}_{L 1} = {v}_{p v} + \frac{{V}_{d {c}_{2}}}{2 n} \qquad ( Equation 1 )$$

Interval 422 may begin when t=dₘT′, and Q₃ is turned off while Q₄ is turned on, meaning that vₚ=vₚᵥ+v_{b}. Because Q₁ can still be conducting, L_{I1} can still be connected to the positive dc rail of the first transformer side, and vₛ can remain unchanged, so v_{L1} can still be the same as Equation 1 as shown in Equation 2. The submodules on the second transformer side may change state at the beginning of interval 424 and the polarity of vₛ may be reversed. Because the first transformer side switches may not change state during this time, the only change in v_{L1} is the sign of the second term in Equation 2.

$${v}_{L 1} = {v}_{pv} - \frac{{V}_{{dc}_{2}}}{2 n} \qquad ( Equation 2 )$$

Interval 426 may begin at t=T′ where Q₄ may be turned off while Q₃ is turned on. Again, L_{I1} can still be connected to the positive dc rail of the first transformer side through Q₁, and since the conditions on the second transformer side may not change, there may be no change in the voltage of L_{I1}. The conduction of Q₃ may, however, result in another zero-state for vₚ. At t=(1+dₘ)T′, Q₁ may be turned off while Q₂ may be turned on. Consequently, L_{I1} may no longer be connected to the positive dc rail but may instead be connected to the negative dc rail, and therefore the energy storage subsystem 72. In interval 428, v_{L1} is defined by Equation 3.

$${v}_{L 1} = - ( {v}_{b} - \frac{{V}_{{dc}_{2}}}{2 n} ) \qquad ( Equation 3 )$$

As interval 430 may be marked by the changing of conduction states on the second transformer side, the sign of the second term in Equation 3 may be flipped, meaning that in interval 430, v_{L1} is defined by Equation 4.

$${v}_{L 1} = - ( {v}_{b} + \frac{{V}_{{dc}_{2}}}{2 n} ) \qquad ( Equation 4 )$$

Given that the voltage v_{L1} has been modelled for the entire switching period, the volt-second balance may be used to determine a relationship between vₚᵥ and v_{b}.

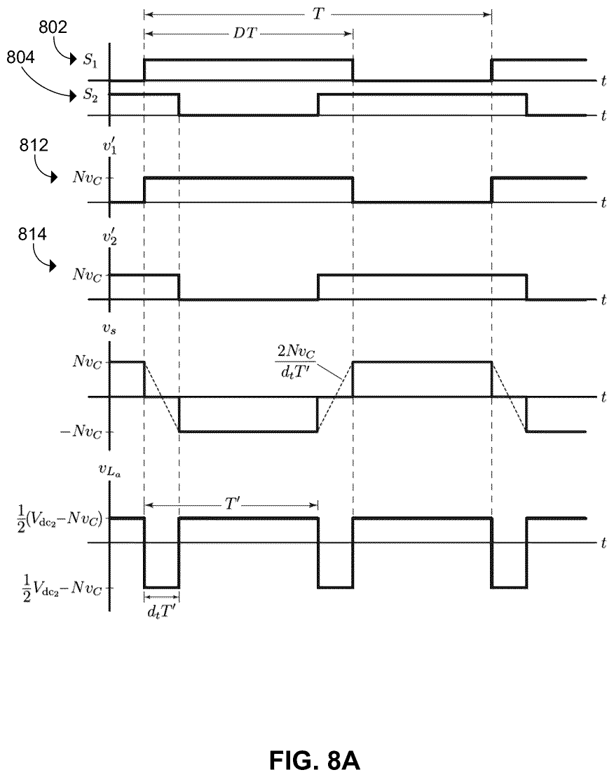

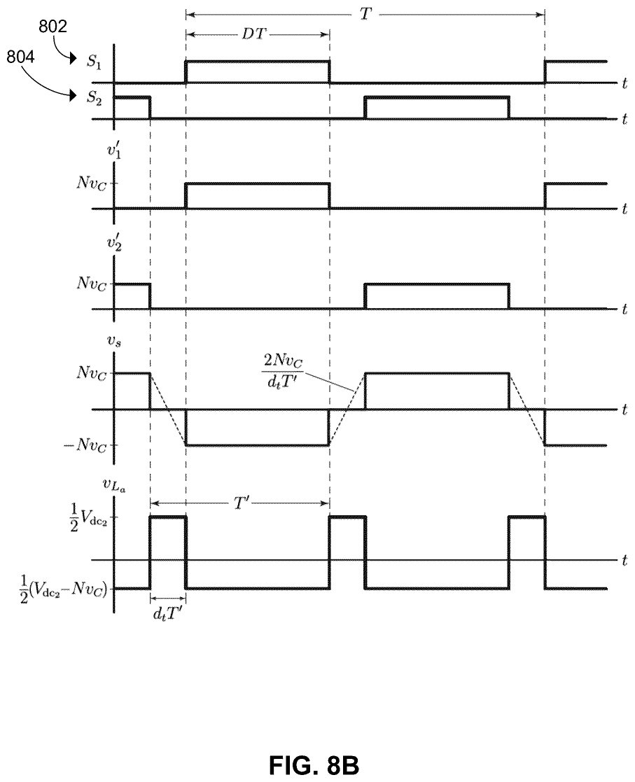

Computing the time average of v_{L1} and setting the result to zero yields,

$$\frac{{v}_{b}}{{v}_{pv}} = \frac{D}{1 - D} \qquad ( Equation 5 )$$

where D may be the duty cycle of the first transformer side switches, and D=dₘ+0.5. Equation 5 indicates that the relationship between the voltage of the energy generation subsystem 12 and the voltage of the energy storage subsystem 72 may be identical to that of a conventional buck/boost converter. As such, the voltage of the energy generation subsystem 12 can be adjusted by varying the duty cycle of the first transformer side to meet the requirements of the MPPT algorithm. In the general case, the amplitude of vₚ may depend directly on two voltages that are expected to vary. That is, the voltage of the energy generation subsystem and the voltage of the energy storage subsystem may not be fixed voltages, in general. As a consequence, the VMS may be used to adjust the voltage vₛ to counteract any fluctuations in v_{b} and vₚᵥ. The VMS may be used by introducing a three-level waveform on the second transformer side instead of the two-level waveform shown in FIGS. 4A and 4B. Accordingly, the vₛ waveform shown in FIGS. 4A and 4B may have a shape that is similar to vₚ, but its amplitude and the length of the zero state would be different. The VMS is described in further detail herein below with reference to FIGS. 8, 10 and 11. The above analysis may be valid nonetheless, because the voltage vₛ may not impact the relationship shown in Equation 5, meaning that MPPT operation of the MPC 100 can be independent of the second transformer side.

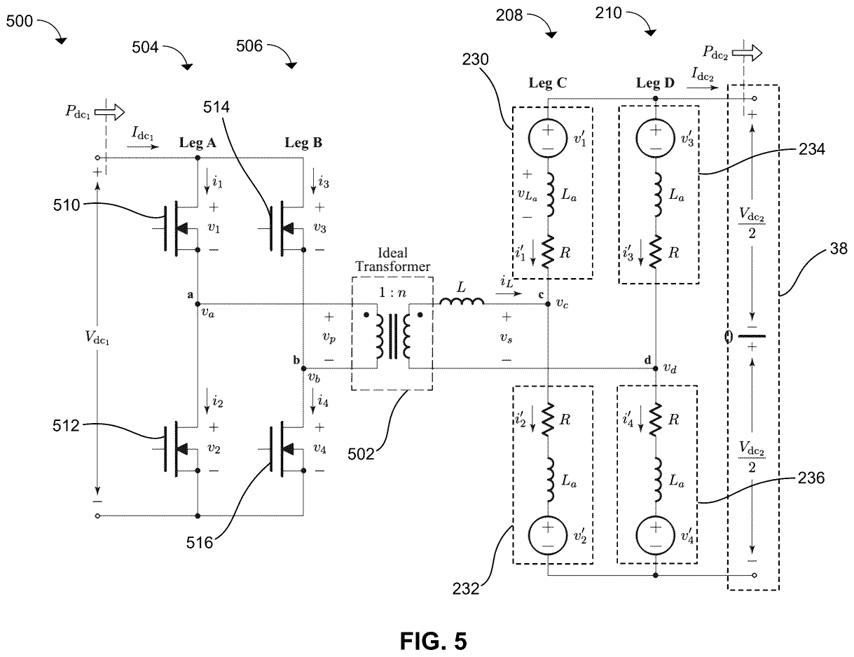

Referring now to FIG. 5, shown therein is an example simplified equivalent circuit model 500 for analysis of the switching control of the submodules of the second transformer side of MPC 100. In the simplified equivalent circuit model 500, the first transformer side of MPC 100 is modified for simplifying the analysis of the second transformer side.

The simplified equivalent circuit model 500 includes circuit branches 504 and 506 (denoted as Leg A and Leg B respectively) on a first side of transformer 502 and circuit branches 208 and 210 (denoted as Leg C and Leg D respectively) on second side of transformer 502. Circuit branch 208 may include first arm 230 and second arm 232. Circuit branch 210 may include third arm 234 and fourth arm 236.

The circuit branches 208 and 210 may be connected to transformer 502 at their midpoints, labelled as nodes c and d, respectively. Circuit branches 208 and 210 may also be connected across a dc voltage V_{dc2}, whose midpoint, denoted by 0, can be regarded as the potential reference for the multiport converter 100, unless otherwise stated. The voltages of nodes c and d may be denoted by v_{c} and v_{d}, respectively.

Each of arms 230, 232, 234, and 236 may include N identical, series-connected submodules that can be represented by a voltage source vⱼ′, where j=1, 2, 3, 4. Each string of submodules may be connected to an arm inductor, Lₐ, and both the copper losses of the arm inductor as well as the conduction losses of the submodules can be combined and modelled by the resistance, R, while the current in each arm may be denoted by iⱼ′. The submodule topologies may be arbitrary, but in the simplest case they may each consist of a half-bridge converter whose dc-side can be connected to a submodule capacitor C.

The dc link current of the second transformer side may be denoted by I_{dc2}, while the power exported through the dc link of the second transformer side may be denoted by P_{dc2}.

On the first transformer side, the transformer 502 may be connected to the ac terminals of a full-bridge converter at nodes a and b whose voltages may be labelled vₐ and v_{b}, respectively. In this case, the arm voltage vⱼ may be equal to the voltage drop across the switch of the arm under consideration, while the arm current iⱼ may be the current flowing through the switch in each arm. The current, voltage and power of the dc link of the first transformer side may be denoted by I_{dc1}, V_{dc1}, and P_{dc1} respectively.

The transformer 502 may be modelled by an ideal 1:n transformer, where n is the turns ratio of the transformer 502, along with a series inductance, L, that may be used to model the leakage inductance of the transformer referred to the second transformer side. The magnetizing inductance of the transformer 502 may be assumed to be large, in general, and may therefore be neglected. The voltage of the second transformer side may be the difference of v_{c} and v_{d}, and can be denoted by vₛ, while the voltage of the first transformer side may be the difference of voltages vₐ and v_{b}, and can be denoted by vₚ.

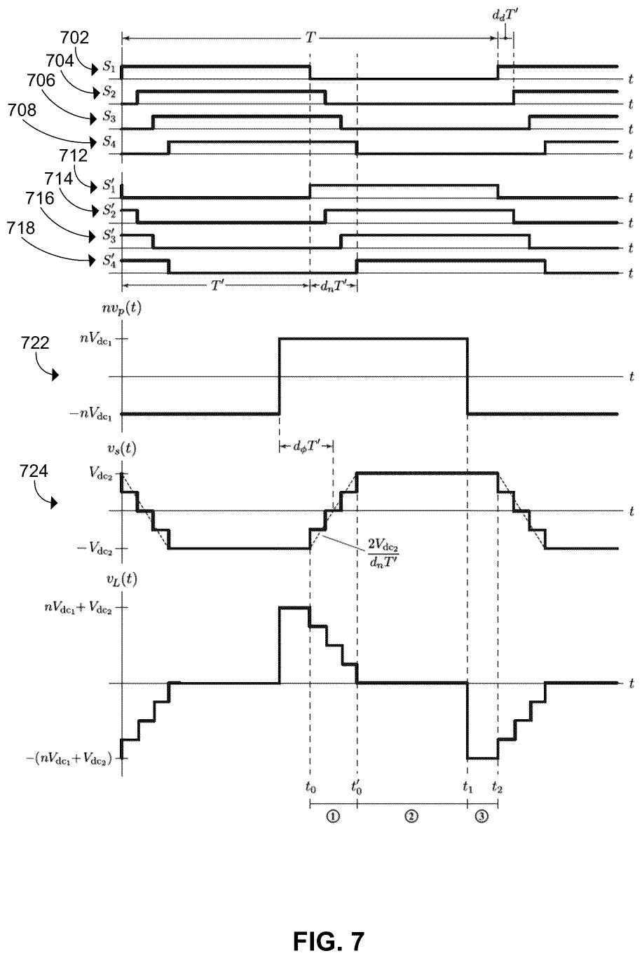

In at least one embodiment, the second transformer side of MPC 100 may operate under a quasi two-level (Q2L) modulation scheme to reduce the dv/dt stresses on the submodules. The Q2L modulation scheme may be implemented by control system 212. The Q2L modulation may also be referred to herein as “trapezoidal” or “staircase” modulation. The Q2L modulation may produce a staggered voltage waveform (e.g., voltage waveform 724 of FIG. 7) instead of a perfectly square waveform.

Control system 212 may perform the switching operation of the arms on the second transformer side in pairs. The submodule switching signal provided by control system 212 may include a first set of switching pulses to drive the submodules in first arm 230 and fourth arm 236. The submodule switching signal may also include a second set of switching pulses to drive the submodules in second arm 232 and third arm 234.

When the submodules in a given arm are required to change states (i.e., change from a bypassed state to an inserted state, or vice-versa), the entire submodule string may be switched with sequential delays. The resulting arm voltage produced by the submodule strings on the second transformer side may therefore resemble stepped “trapezoidal” waveforms as explained in further detail herein below with reference to FIG. 7. For example, the first set of switching pulses may be produced in a coordinated sequence in terms of pulse duration and repetition to generate a stepped trapezoidal arm voltage of the first arm. In contrast, the switches on the first transformer side may be switched using a conventional bipolar PWM switching scheme. For example, the two switches in a given leg (e.g., switching devices 510 and 512) may be switched by complimentary pulses, while the two legs (Leg A and Leg B) on the first transformer side may be switched in a complimentary fashion. The switching pulses of the first transformer side and the second transformer side may be phase-shifted relative to one another such that the power throughput of the multiport converter 100 can be controlled through the voltages of the transformer terminals. The phase-shift required to achieve the rated power may be determined based on the equations for P_{T} described herein below. In some embodiments, the phase-shift may be limited to relatively small values (e.g., <about 10% of the total switching period) to reduce reactive losses in MPC 100 and maintain a fairly linear relationship between the power and phase-shift.

Based on FIG. 5, the current i_{L} can be defined in Equation 6.

$${i}_{L} = - {i}_{1}^{′} + {i}_{2}^{′} = {i}_{3}^{′} - {i}_{4}^{′} \qquad ( Equation 6 )$$

The common-mode currents, i_{σc} and i_{σd}, of Leg C and Leg D, respectively, can be defined in Equations 7 and 8, respectively.

$${i}_{σ c} {=}^{Δ} \frac{{i}_{1}^{′} + {i}_{2}^{′}}{2} \qquad ( Equation 7 )$$

$${i}_{σ d} {=}^{Δ} \frac{{i}_{3}^{′} - {i}_{4}^{′}}{2} \qquad ( Equation 8 )$$

Using Equations 6-8, the arm currents of the second transformer side can then be expressed entirely in terms of the transformer current of the second transformer side and common-mode currents of the legs as shown in Equations 9 to 12.

$${i}_{1}^{′} = {i}_{σ c} - \frac{1}{2} {i}_{L} \qquad ( Equation 9 )$$

$${i}_{2}^{′} = {i}_{σ c} + \frac{1}{2} {i}_{L} \qquad ( Equation 10 )$$

$${i}_{3}^{′} = {i}_{σ d} + \frac{1}{2} {i}_{L} \qquad ( Equation 11 )$$

$${i}_{4}^{′} = {i}_{σ d} - \frac{1}{2} {i}_{L} \qquad ( Equation 12 )$$

Since the transformer may not transfer any dc current between the first transformer side and the second transformer side, the common-mode currents i_{σc} and i_{σd} may both be equal to −(½)I_{dc2}. Next, the voltage v_{c} can be determined by using Kirchoff's Voltage Law (KVL) on Leg C as shown in Equation 13.

$${v}_{c} = \frac{1}{2} ( - {v}_{1}^{′} + {v}_{2}^{′} ) + \frac{{L}_{a}}{2} \frac{d}{dt} ( - {i}_{1}^{′} + {i}_{2}^{′} ) + \frac{R}{2} ( - {i}_{1}^{′} + {i}_{2}^{′} ) \qquad ( Equation 13 )$$

Substituting Equation 6 into Equation 13 yields Equation 14.

$${v}_{c} = \frac{1}{2} ( - {v}_{1}^{′} + {v}_{2}^{′} ) - \frac{{L}_{a}}{2} \frac{{di}_{L}}{dt} - \frac{R}{2} {i}_{L} \qquad ( Equation 14 )$$

A similar process can be carried out to determine v_{D} based on Leg D as shown in Equation 15.

$${v}_{d} = \frac{1}{2} ( - {v}_{3}^{′} + {v}_{4}^{′} ) + \frac{{L}_{a}}{2} \frac{{di}_{L}}{dt} + \frac{R}{2} {i}_{L} \qquad ( Equation 15 )$$

An expression for the voltage vₛ in terms of the voltages of the second transformer side can be obtained by taking the difference of Equations 14 and 15 as shown in Equation 16.

$${v}_{s} = \frac{1}{2} ( - {v}_{1}^{′} + {v}_{2}^{′} - {v}_{3}^{′} + {v}_{4}^{′} ) - ( {L}_{a} \frac{{di}_{L}}{dt} + {Ri}_{L} ) \qquad ( Equation 16 )$$

In Equation 16, the second term on the right-side of the equation may describe dynamic behaviour and the drop in voltage due to the arm inductors, while the first term may be the voltage applied to the second transformer side by the submodule arms. Furthermore, since the multiport converter 100 may be intended to operate such that the submodule strings are switched in diagonal pairs (i.e., first arm 230 may have the same conduction state as fourth arm 236), it can be concluded that v₁′=v₄′ and v₂′=v₃′. Therefore, under steady state conditions and the assumption that the R is negligible, the voltage applied to the transformer on the MV-side can be expressed as shown in Equation 17.

$${v}_{S} = - {v}_{1}^{′} + {v}_{2}^{′} \qquad ( Equation 17 )$$

By repeating the aforementioned process on the first transformer side, the voltage vₚ can be expressed as shown in Equation 18.

$${v}_{p} = - {v}_{1} + {v}_{2} \qquad ( Equation 18 )$$

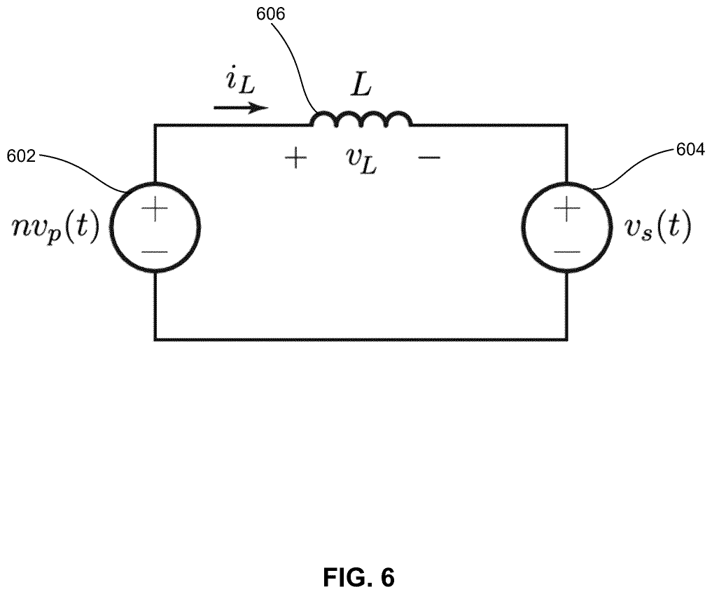

In at least one embodiment, the switching states of the first transformer side and the second transformer side may be phase-displaced relative to one another to control the power throughput of the multiport converter 100. Referring now to FIG. 6, shown therein is a simplified circuit representation of the equivalent circuit model of FIG. 5. In FIG. 6, the entire multiport converter 100 may be represented by two voltage sources 602 (denoted as nvₚ(t)) and 604 (denoted as vₛ(t)) connected by an equivalent inductance 606 (denoted as L) that represents the leakage inductance of the center-tapped transformer, along with any other stray inductances present in the circuit. The voltages nvₚ(t) and vₛ(t) may represent the voltages applied to the transformer at the first transformer side and the second transformer side, respectively, both referred to the second transformer side.

Reference is next made to FIGS. 5 to 7. FIG. 7 shows example switching pulse waveforms and voltage waveforms with reference to the equivalent circuit models shown in FIGS. 5 and 6, wherein each of arms 230, 232, 234 and 236 includes four series-connected submodules. In other examples, each of arms 230, 232, 234 and 236 may include a different number of series-connected submodules.

In FIG. 7, a full switching period of the multiport converter 100 may be denoted as T while a half-period may be denoted as T′. Control system 212 may provide a first set of switching pulses 702, 704, 706 and 708 (denoted as S₁, S₂, S₃ and S₄ respectively) to first arm 230 and fourth arm 236. Control system 212 may provide a second set of switching pulses 712, 714, 716 and 718 (denoted as S₁′, S₂′, S₃′ and S₄′ respectively) to second arm 232 and third arm 234.

To facilitate the Q2L modulation scheme, the switching pulses for a given arm may be delayed by a small fraction of the switching period, denoted by d_{d}T′, where d_{d} is a dimensionless quantity referred to as the delay ratio, with 0≤d_{d}≤1. In FIG. 7, the duration of the delay d_{d}T′ may be exaggerated to clearly demonstrate its effect on the overall operation of the multipoint converter 100. In actual operation, the total duration of the delay in the switching pulses may be much smaller than the switching period (for example, the duration of the delay d_{d}T′ may be selected to have an overall delay dₙT′ be no larger than 2-3% of the total switching period T). The time that it takes for vₛ(t) to transition from its positive peak to its negative peak (or vice-versa) may be defined as dₙT′, where dₙ is a dimensionless quantity referred to as the transition ratio. The total transition time, in this case, can be equal to (N−1)d_{d}T′ and may be much smaller than the switching period, meaning that dₙ<<1. The transition ratio dₙ may be controlled to achieve a number of different objectives, as described in further detail herein below.

As shown in FIG. 7, the voltage waveform 722 corresponding to the first transformer side may be phase-displaced relative to the voltage waveform 724 corresponding to the second transformer side by a phase-shift of d_{φ}T′, where d_{φ} is a dimensionless coefficient referred to as the phase-shift ratio. The phase-shift ratio d_{φ} may be defined as the phase displacement between the rising edge of nvₚ and the zero crossing of the voltage vₛ, as shown in FIG. 7. Furthermore, when d_{φ} is positive nvₚ leads vₛ and power can flow from the first transformer side to the second transformer side. When d_{φ} is negative, nvₚ lags vₛ and power can flow from the second transformer side to the first transformer side. The power throughput of the multiport converter 100 can be represented by the Equation 19:

$${P}_{T} = \frac{{V}_{{dc}_{2}}^{2} {T}^{′}}{2 LK} ( - \frac{{d}_{n}^{2}}{6} + 2 {d}_{ϕ} ( 1 - \vert {d}_{ϕ} \vert ) ) \qquad ( Equation 19 )$$

where K is referred to as the dc link voltage ratio and is defined as

$$K {=}^{Δ} \frac{{V}_{dc 2}}{{nV}_{dc 1}} .$$

In Equation 19, the absolute value of d_{φ} may be included in the bracket to account for the direction of power flow because d_{φ} can be positive or negative. When d_{φ}>0, P_{T}>0 and power flows towards the second transformer side. When d_{φ}<0, P_{T}<0, and power flows towards the first transformer side.

Reference is next made to FIGS. 8A and 8B showing example switching pulse waveforms and voltage waveforms of the second transformer side (with reference to the equivalent circuit models shown in FIGS. 5 and 6) for implementation of VMS under two different conditions. During operation of the multiport converter 100, V_{dc1} may be connected to a renewable energy generation subsystem 12 while V_{dc2} may be connected to a DC collection network. Therefore, it may be assumed that the voltage V_{dc2} is fixed while the voltage V_{dc1} is variable.

As described herein above using Equation 17, the terminal voltage of the second transformer side may only be dependent on the arm voltages v₁′ and v₂′. The arm voltages v₁′ and v₂′ may themselves be dependent on the submodule capacitor voltages in each arm, implying that the voltage vₛ can be controlled if the submodule capacitor voltages can be controlled. To simplify the analysis, the Q2L modulation scheme may be ignored because the delay ratio is typically very small relative to the total period. Accordingly, the following analysis assumes that all the submodules in a given arm on the second transformer side switch states simultaneously.

In FIGS. 8A and 8B, the switching pulse 802 (denoted as S₁) may be applied to all the submodules in first arm 230 and fourth arm 236 simultaneously. The switching pulse 804 (denoted as S₂) may be applied to all the submodules in second arm 232 and third arm 234 simultaneously. As can be seen with reference to switching pulses 802 and 804, the submodules of the two arms in a given leg (e.g., first arm 230 and second arm 232 of Leg C) may not be switched in a completely complementary manner when the VMS is applied. Instead, the switching pulses may be shifted such that there is a duration in which both S₁ and S₂ are high (or low depending on the condition). The duration between the rising edge of S₁ and falling edge of S₂ is referred to hereafter as the matching time denoted by tₜ, and defined as:

$${t}_{t} {=}^{△} {d}_{t} {T}^{′} \qquad ( Equation 20 )$$

where dₜ is a dimensionless coefficient referred to as the matching ratio.

By performing KVL on the second transformer side, it can be shown that:

$${V}_{{dc}_{2}} - {v}_{1}^{′} - 2 {v}_{{L}_{a}} - {v}_{s} - {v}_{4}^{′} = 0 \qquad ( Equation 21 )$$

where v_{La} is the voltage drop across the arm inductor Lₐ. Then, because v1′=v4′, Equation 21 can be simplified as shown in Equation 22.

$${v}_{{L}_{a}} = \frac{1}{2} ( {V}_{{dc}_{2}} - 2 {v}_{1}^{′} - {v}_{s} ) \qquad ( Equation 22 )$$

As shown in FIG. 8A, v_{La} may have a period of T′. Because the volt-second balance can require that the average of v_{L} may be zero over T′ under steady-state conditions, Equation 22 can be used to show that:

$$\frac{1}{2} ( {V}_{{dc}_{2}} - 2 {v}_{1}^{′} ) {d}_{t} {T}^{′} + \frac{1}{2} ( {V}_{{dc}_{2}} - 2 {v}_{1}^{′} - {Nv}_{C} ) ( 1 - {d}_{t} ) {T}^{′} = 0 \qquad ( Equation 23 )$$

and simplification of Equation 23 may result in Equation 24.

$${Nv}_{C} = \frac{{V}_{{dc}_{2}}}{{d}_{t} + 1} \qquad ( Equation 24 )$$

The primary objective of the VMS may be to ensure that the amplitude of vₛ can be adjusted to be equal to track nvₚ. In other words, the amplitude of the transformer terminal voltage may be adjusted to track and be approximately equal to the the voltages applied to the transformer at the first transformer side. Based on Equation 17, vₛ is directly dependent upon v₁′ and v₂′, which are in turn both dependent on Nye as voltage waveforms 812 and 814 in FIG. 8A illustrate. By controlling the amplitudes of v₁′ and v₂′, the amplitude of vₛ can be controlled as well. To achieve this control, the submodule capacitor voltage v_{C}, can be adjusted using dₜ according to Equation 24. Accordingly, by ensuring that Nye is always equal to nV_{dC1}, the amplitude of vₛ can always be equal to that of nvₚ. Inspection of Equation 24 shows that dₜ>0 for nV_{dC1}<V_{dc2} (K>1), and dₜ<0 for nV_{dC1}>V_{dc2} (K<1). The case where dₜ>0 is already shown in FIG. 8A. However, for dₜ<0 the waveforms of FIG. 8A may be slightly different. The parameter dₜT′ may be defined as the duration between the rising edge of S₁ and the falling edge of S₂, but when dₜ<0, the falling edge of S₂ can appear before the rising edge of S₁. This means that both S₁ and S₂ can be low during dₜT′ in contrast to the case where dₜ>0 and both S₁ and S₂ can be high during dₜT′. The set of waveforms for the case where dₜ<0 are shown in FIG. 8B.

Based on the switching patterns shown in FIGS. 8A and 8B, it can be seen that:

$${T}^{′} + {d}_{t} {T}^{′} = DT \qquad ( Equation 25 )$$

which implies that:

$${d}_{t} = 2 D - 1 \qquad ( Equation 26 )$$

and Equation 26 may relate the transition ratio dₜ to the duty cycle D of the switching pulses on the second transformer side.

The VMS may be effective in helping the amplitudes of vₛ and nvₚ to be matched; however, the matching may not be able to be performed indefinitely. For example, a challenge for the matching ability of the VMS may be a result of the overlap of gating pulses during dₜT′ of each half-period, referred to hereafter as the zero state. Simply put, the larger the deviation between the terminal voltages, the larger the dₜT′ that may be used to aid in their matching. As seen in FIGS. 8A and 8B, the upper limit on dₜT′ may be T′, meaning that |dt|<1, otherwise the pulses S₁′ and S₂′ may always be low meaning vₛ may always be zero. The voltage Nye may always have to be equal to V_{dc1} to ensure that the amplitudes of nvₚ and vₛ are matched. Applying this condition to Equation 24 can yield Equation 27.

$${d}_{t} = \frac{{V}_{{dc}_{2}}}{n {V}_{{dc}_{1}}} - 1 \qquad ( Equation 27 )$$

Because the amplitudes of the transformer terminal voltages are directly related to the dc link voltage, it may be more practical to write Equation 27 in terms of K instead as shown in Equation 28.

$${d}_{t} = K - 1 \qquad ( Equation 28 )$$

The restriction of |dt|<1 gives rise to bounds for the ratio K as shown in Equation 29.

$$0 < K < 2 \qquad ( Equation 29 )$$

When K=1, the VMS may not be required and therefore dₜ=0. In theory, if K<1 the VMS can match the terminal voltages of the transformer indefinitely. On the other hand, for K>1, the VMS can match the voltages so long as K<2, meaning nV_{dc1}=(½)V_{dc2}. However, in both of these cases, the amount of power that the multiport converter 100 can transfer may be limited due to the zero state that is produced in vₛ. The power throughput of the multiport converter 100 operating with the VMS can be modelled using Equation 19 by accounting for the zero state, as well as the fact that the amplitude of the terminal voltage of the second transformer side may be Nye instead of V_{dc2} when the VMS is implemented, and Equation 24 indicates that N_{vc}=V_{dc2}. Moreover, the time for the voltage vₛ to transition from −V_{dc2} to V_{dc2} may increase under the VMS, meaning dₙT′ should be modified to account for the zero state. The transition ratio can therefore no longer be equal to (N−1)d_{d}T′, but can instead be expressed as:

$${d}_{n} {T}^{′} = {d}_{0} {T}^{′} + \vert {d}_{t} \vert {T}^{′} \qquad ( Equation 30 )$$

where d₀T′≅(N−1)d_{d}T′. Equation 30 can include the magnitude of dₜ because dₜ can be a negative number, but the transition time must be a positive number. By substituting Equation 30 into Equation 19, the power throughput of the multiport converter 100 operating under VMS can be written as shown in Equation 31.

$${P}_{T}^{′} = \frac{{V}_{{dc}_{2}}^{2} {T}^{′}}{2 {LK}^{2}} ( - \frac{{( {d}_{0} + {d}_{t} )}^{2}}{6} + 2 {d}_{ϕ} ( 1 - \vert {d}_{ϕ} \vert ) ) \qquad ( Equation 31 )$$

The variation in power throughput caused by the VMS can be seen in that the numerator of the first term inside the parenthesis of Equation 31 has increased relative to that of Equation 19. Such a variation can be expected because increasing dₜ can result in the variation of the non-zero segments of vₛ, thereby reducing the duration of the intervals in which power can be transferred. The variation in power can be quantified by the ratio of Equations 31 and 19, and may be denoted by p as shown in Equation 32.

$$β {=}^{Δ} \frac{{P}_{T}}{{P}_{{T}^{′}}} = \frac{1}{K} \frac{{( {d}_{0} + K - 1 )}^{2} + 12 {d}_{ϕ} ( 1 - \vert {d}_{ϕ} \vert )}{{d}_{0}^{2} + 12 {d}_{ϕ} ( 1 - \vert {d}_{ϕ} \vert )} \qquad ( Equation 32 )$$

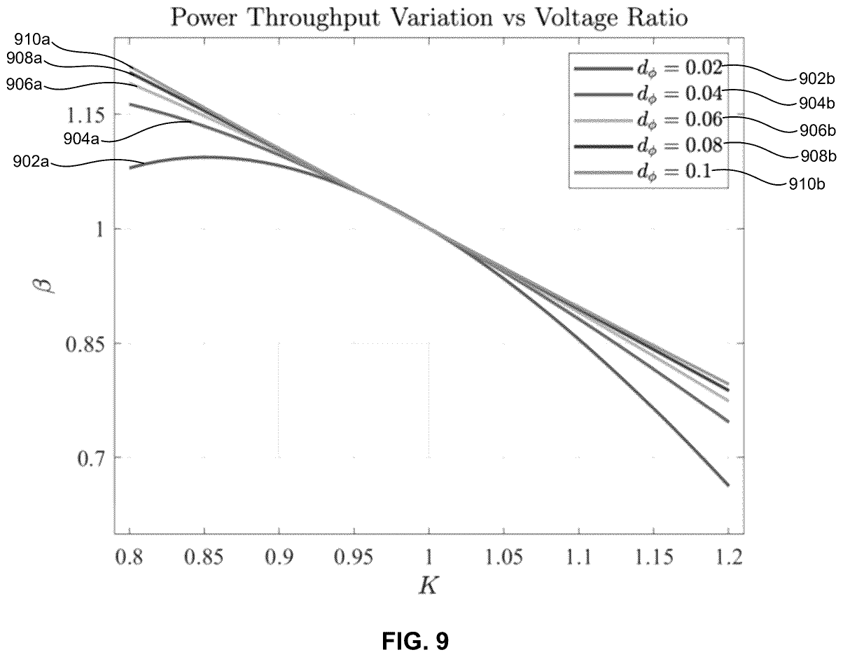

The ratio dₜ may be replaced by (K−1) in Equation 32 as it can be more practical to consider the variation of power throughput as a function of the multiport converter's voltage ratio. Referring now to FIG. 9, shown therein is the relationship between the power throughput and voltage ratio of the multiport converter 100 for various operating points. The family of curves 902a-910a for phase-shift ratios (d_{φ}) 902b-910b may indicate that the power throughput of the multiport converter decreases substantially as K>1 and the power throughput increases for K<1. Both of these may be expected because K>1 may mean that V_{dc1} has decreased, while K<1 may mean that V_{dc1} has increased. In at least one embodiment, the acceptable drop in power throughput may be known in advance, meaning the allowable range of operation of the VMS can be determined according to the power requirements. For example, the range of operation of the VMS can be determined by first establishing a threshold for allowable reduction in power while maintaining optimal operations (VMS and MPPT). For an example threshold of 15% allowable reduction in power, the corresponding change in the phase-shift ratio can be calculated using the equation for P_{T} (as described herein above). The required values for d_{φ} can be used to determine the maximum dₜ using Equation 33. The maximum dₜ can then be used to determine the maximum variation in K that can be acceptable based on Equation 28.

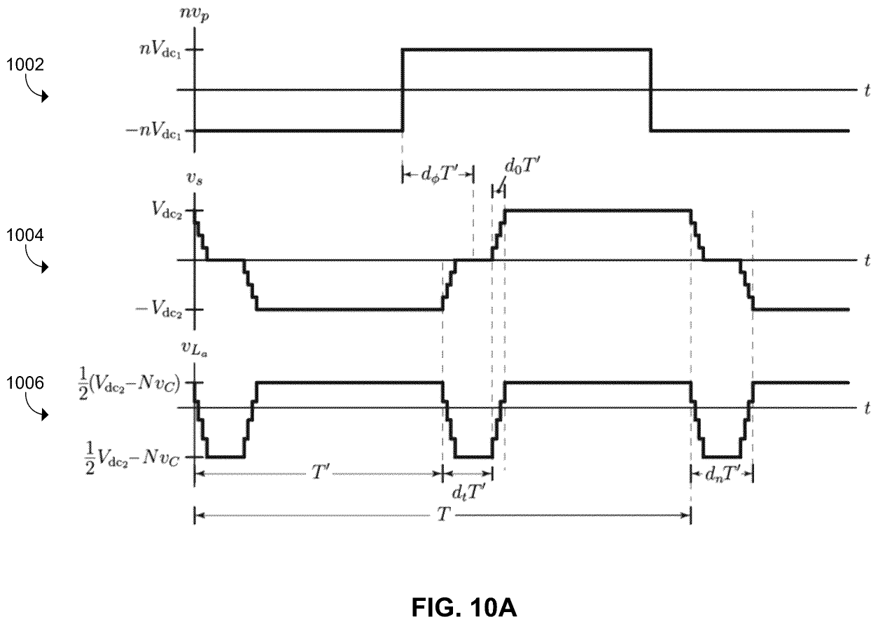

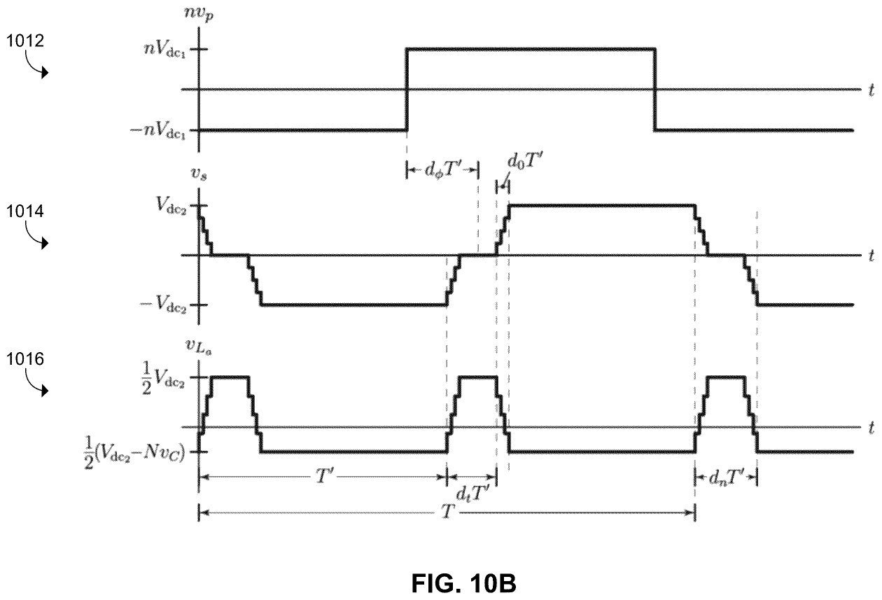

Referring now to FIGS. 10A and 10B, shown therein are example voltage waveforms (with reference to the equivalent circuit models shown in FIGS. 5 and 6) for implementation of VMS under two different conditions. As can be seen in the voltage waveforms 1002, 1004, 1006, 1012, 1014, and 1016, there may be an additional limitation on the VMS that can arise from the relationship between d_{φ} and dₜ. The point in time where vₛ begins to increase from −V_{dc2} can coincide with the beginning of the interval defined by dₜT′. As K deviates from 1, the duration dₜT′ may increase as dictated by the VMS. As d_{φ} is fixed for a given power throughput, it can be possible that K deviates far enough such that the interval defined by dₜT′ begins before the rising edge of nvₚ. Although such circumstances may not result in catastrophic damage to the multiport converter 100, the polarities of the transformer voltages may produce irregularities in the transformer current, thereby increasing the reactive power losses in the multiport converter 100 and consequently, may defeat the purpose of the VMS. Therefore, the degree to which the VMS can maintain regulation may also be limited by d_{φ}T′. In the case where the interval denoted by dₜT′ begins at the rising edge of nvₚ, d_{φ}=dₜ. Therefore, the following restriction on dₜ may ensure that the multiport converter 100 operates in an approximately optimal manner as shown in Equation 33.

$${d}_{t} < 2 {d}_{ϕ} \qquad ( Equation 33 )$$

Violating the restriction of Equation 33 may not cause any harm to the multiport converter 100, nor is it a theoretical limit. Instead, this restriction can ensure that the current i_{L} may remain approximately perfectly trapezoidal when the VMS is applied. If this restriction is violated, the edges of i_{L} may have irregularities due to the irregularly shaped voltage v_{L} that may exist as a consequence of the violation.

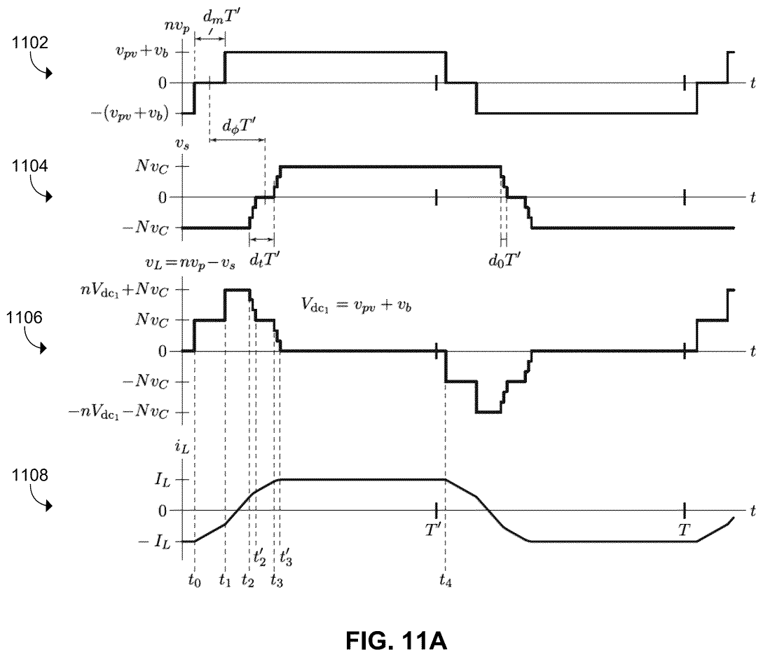

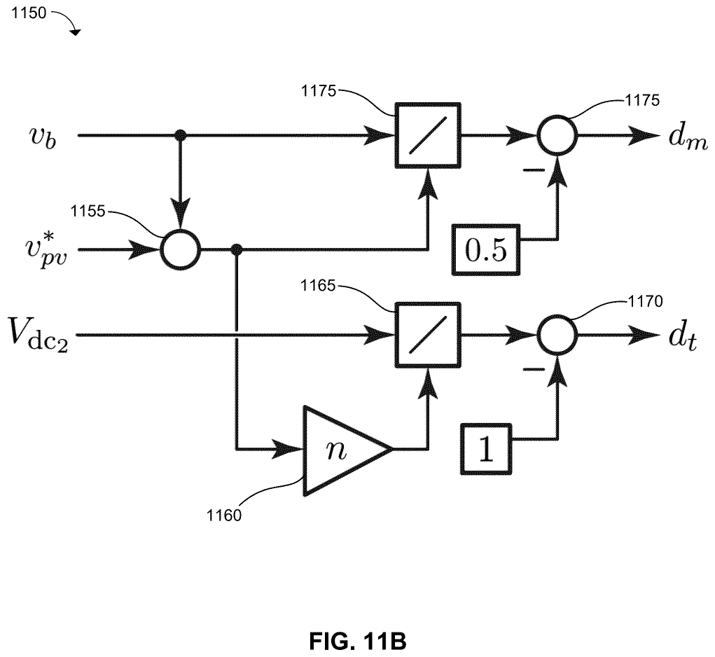

Referring now to FIG. 11A, shown therein are example voltage waveforms (with reference to the equivalent circuit model of MPC 100 shown in FIG. 3) corresponding to VMS implementation on the second transformer side. The assumptions made above during the analysis for Equations 1 to 5 may not hold true when considering the power throughput of MPC 100 because the power throughput may depend substantially on the terminal voltages of the transformer 202. Therefore, the following analysis considers the general case where the second transformer side of MPC 100 may employ VMS to ensure that the ratio of the voltages applied to the transformer 202 approximately matches its turns ratio.

In at least one embodiment, the voltage V_{dc2} can be expected to be constant as the second transformer side may be connected to a medium-voltage DC network. In contrast, the sum of the voltages of the energy generation subsystem 12 and the energy storage subsystem 72 may vary depending on the ambient conditions and the charge status of the energy storage subsystem 72. According to FIG. 4, these variations may significantly impact the amplitude of vₚ. To eliminate the detrimental effects of the first transformer side voltage variations, control system 212 may implement the VMS for the second transformer side. Control system 212 may implement the VMS by creating a three-level waveform for vₛ to adjust the submodule capacitor voltages of the second transformer side. The amplitude of vₛ may consequently be set to n(vₚᵥ+v_{b}) to aid the voltages of the transformer's terminals in approximately matching its turns ratio. Control system 212 may generate dₘ and dₜ based on the measured battery voltage v_{b}, desired PV voltage vₚᵥ* and second transformer side dc link voltage V_{dc2}.

Reference is now made to FIG. 11B showing a block diagram representation 1150 of a method by which dₘ and dₜ can be generated, based on measured values of v_{b}, V_{dc2} and a target v*ₚᵥ, to control vₘ and N_{Vc} respectively. The sum (1155) of v_{b} and v*ₚᵥ can constitute the dc link voltage of the first transformer side, denoted by V_{dc1}. The measured voltage V_{dc1} can be scaled (1160) by the turns ratio, n, to refer the measured voltage to the second transformer side. dₜ can be calculated by dividing (1165) the measured V_{dc2} by n*V_{dc1} and subtracting (1170) 1 from the result (based on Equation 27 described herein above). dₘ can be generated by dividing (1175) the measured v_{b} by the calculated V_{dc1} and subtracting (1175) 0.5 from the result (using Equation 5 adapted for dₘ instead of D as described herein above). The generated dₘ and dₜ may then be used in conjunction with the standard PWM to generate the voltage waveforms for the transformer terminal voltages.

Referring back to FIG. 11A, the voltage waveforms 1102, 1104, 1106 and 1108 shown in FIG. 11A show some of the voltages and currents of the transformer in MPC 100, all referred to the second transformer side. As FIG. 11A shows, vₛ may be a three-level waveform and dₜ may be the matching ratio. The voltage (nᵥₚ−vₛ) may be considered as the leakage voltage v_{L}, while the current i_{L} may be the second transformer side-referenced current of the transformer. The sum (vₚᵥ+v_{b}) may be referred to as V_{dc1} for the sake of brevity.

The power throughput of the multiport converter 100 can be modelled by following the same process as described above with reference to Equation 19. The energy throughput of the multiport converter 100 in each interval can be determined by multiplying vₛ(t) and i_{L}(t) in each respective interval. Dividing the resulting energy throughput by T′ can result in an equation for the total average power throughput of the multiport converter 100 as shown in Equation 34.

$${P}_{T} = \frac{{Nv}_{c} {T}^{′}}{2 L} [ {nV}_{{dc}_{1}} ( 2 {d}_{ϕ} ) ( 1 - \vert {d}_{ϕ} \vert ) + {nV}_{{dc}_{1}} ( \frac{{K}^{2} - 4 K - {D}^{2} + D + \frac{11}{4}}{2} - \frac{{d}_{0}^{2}}{6} ) + {Nv}_{c} ( K - 1 ) ( 2 - K ) ] \qquad ( Equation 34 )$$

In at least one embodiment, the degree to which the transformer terminal voltages can be matched by the VMS may be limited due to the presence of the zero state in the second transformer side voltage waveform. The limitation on dₜ for MPC 100 can therefore be determined based on similar reasoning as described herein above with reference to FIGS. 8-10 as shown in Equation 35.

$$\vert {d}_{t} \vert < 1 \qquad ( Equation 35 )$$

The restriction on dₜ may give rise to the same limitation on the dc link voltage ratio, K, which can be matched by the multiport converter 100 as described herein above with reference to Equation 29. Accordingly, the multiport converter 100 can match the voltages of the transformer terminals if 0<K<2. This may set a theoretical limit on the dc link voltage ratio K. In some embodiments, a more practical limit on the on the dc link voltage ratio K may be set according to d_{φ}.

In at least one embodiment, the MPC 100 makes use of a zero state on the first transformer side to achieve MPPT, that may result in an additional constraint on the operating characteristics of MPC 100. Although a similar restriction as Equation 35 can be applied to dₘ, the duty ratio of the first transformer side may provide a more restrictive requirement. Because the duty ratio of the first transformer side may be bounded between 0 and 1, using Equation 5 and the fact that D=dm+0.5 the range for dₘ can be shown as in Equation 36.

$$- 0.5 \leq {d}_{m} \leq 0.5 \qquad ( Equation 36 )$$

The restriction of Equation 35 may indicate the theoretical limit of dₘ, but in some practical settings, the range may be more limited than the theoretical limit. In at least one embodiment, semiconductor switches are switched with duty cycles between about 30% to about 70%. The practical MPPT range of the multiport converter 100 may therefore decrease as dₘ may be limited to an approximate range from about −0.2 to about 0.3.

A similar constraint as Equation 33 may be imposed on the MPC 100 as dictated by the waveforms of FIG. 11A. Because d_{φ} is defined as the phase-shift between the middle of the zero states of the first transformer side and the second transformer side, it may follow that:

$$\frac{{d}_{m} + {d}_{t}}{2} < {d}_{ϕ} \qquad ( Equation 37 )$$

The power throughput of the multiport converter 100 may be governed by d_{φ}, meaning that the operating point of MPC 100 may directly limit both the MPPT range of the first transformer side, as well as the second transformer side's ability to regulate the voltage vₛ through the VMS. Additionally, because the phase-shift ratio may typically be set to relatively small values (around 0.1-0.2), the limit on dₜ and dₘ that is set according to Equation 37 may end up being the most restrictive of the aforementioned ranges of operation.

In addition to the practical considerations described above, the ranges of both dₜ and dₘ may also be limited by the fact that the introduction of zero states in the transformer terminal voltages can reduce the power throughput capacity of the multiport converter 100 under certain operating conditions. As such, it may be important to maintain a balance between the multiport converter's ability to match the transformer terminal voltages and achieve MPPT, while maintaining a sufficient power throughput capacity. The appropriate balance may be dictated on a case-by-case basis depending on the application and circumstances of the application. For example, the ranges of dₜ and dₘ may be limited by the threshold for allowable reduction in power while maintaining optimal operations (VMS and MPPT), as described herein above.

The power characteristics of MPC 100 may be better understood by decomposing Equation 34 into three different equations for the three different components that contribute to the overall power throughput. The first component, PTO, can be the power throughput in the case where dₜ and dₘ are both equal to zero, which may correspond to the simplest case of the phase-shifted modulation scheme. The delay caused by the Q2L modulation may be attributed to this component for simplicity, and also because the Q2L may not be uniquely tied to either of the two other power components or modes of operation. An additional component for the power that is lost due to the introduction of the VMS, P_{T,dt}, and another component for the MPPT, P_{T,dm}, can be introduced based on the decomposition of Equation 34. Such a decomposition may result in Equations 38 to 40.

$${P}_{T 0} = \frac{N {v}_{C} {T}^{′}}{2 L} [ n {V}_{{dc}_{1}} ( 2 {d}_{ϕ} ( 1 - \vert {d}_{ϕ} \vert ) - \frac{{d}_{0}^{2}}{6} ) ] \qquad ( Equation 38 )$$

$${P}_{T , dt} = \frac{N {v}_{C} {T}^{′}}{2 L} [ n {V}_{{dc}_{1}} ( \frac{{d}_{t}^{2}}{2} - {d}_{t} ) - {Nv}_{C} ( {d}_{t}^{2} - {d}_{t} ) ] \qquad ( Equation 39 )$$

$${P}_{T , dm} = \frac{{Nv}_{C} {T}^{′}}{2 L} [ n {V}_{{dc}_{1}} ( - \frac{{d}_{m}^{2}}{2} ) ] \qquad ( Equation 40 )$$

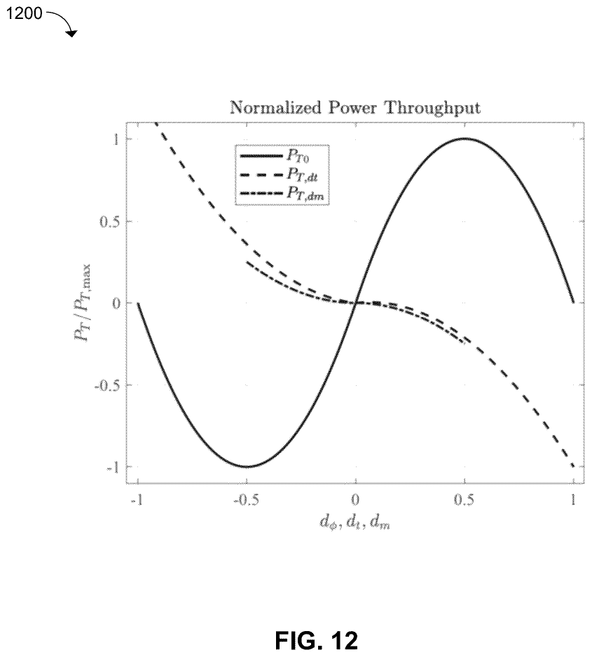

Reference is now made to FIG. 12 showing a graph 1200 of variation of the different components of power in MPC 100 normalized to its maximum power throughput. Graph 1200 includes curves corresponding to Equations 38-40 and the total power throughput for a given operating point may be the sum of the three curves. Each of the curves may be normalized to Equation 38 evaluated at d_{φ}=0.5.

The solid black curve may represent the power throughput of the multiport converter 100 in the absence of the MPPT and VMS, meaning both dₜ and dₘ are zero. In this case, the x-axis variation may be taken as d_{φ}, which may control the magnitude and direction of power flow as shown in Equation 38.

The simple dashed curve may show the power variation of the reduction in power that can be caused by the zero-state produced by dₜ. In this case, the power variation may be directly dependent upon dₜ, meaning the x-axis variation may be taken as dₜ. For example, when dₜ=1, Equation 39 can produce the same result as Equation 38 does at d_{φ}=0.5. Although this may be a logical conclusion from a mathematical perspective, from a practical perspective, the voltage applied to the second transformer side of the transformer when dₜ=1 may always be zero, because dₜ=1 can mean that the zero state on the second transformer side occupies the entirety of the period. These values may be included in the curve because the multiport converter 100 can theoretically operate under such conditions, although it may not be useful for practical applications.

The alternately-dashed curve may show the variation of the power produced by the zero state on the first transformer side to achieve MPPT through dₘ. In this case, the curve may only be defined from −0.5 to 0.5 as a result of Equation 36, and the x-axis may be considered to represent dₘ. The nature of this curve may be similar to that of P_{T,dt} although the decrease in power due to dₘ may be less than that of dₜ due to the nature of the variables and their definitions. In at least one embodiment, a zero-state introduced to either side of the transformer may have the same impact on the power transfer as a whole. Overall, the power throughput of the multiport converter 100 for any operating point may be the summation of the three curves shown in graph 1200.

Graph 1200 can provide insight on how the various components of power change with their respective degrees of freedom. However, the overall reduction in the multiport converter's power throughput caused by variations in the dc link ratio may be another aspect to be considered for MPC 100. The ratio of Equation 34 to Equation 38 can be used to determine how the power throughput of MPC 100 may depend on K in the presence of the VMS. The ratio may be denoted as βₘ, and can be written as shown in Equation 41.

$${β}_{m} {=}^{Δ} \frac{{P}_{T}}{{P}_{T 0}} = \frac{\begin{matrix}12 {d}_{ϕ} ( 1 - \vert {d}_{ϕ} \vert ) + 3 ( {K}^{2} - 4 K + 2.75 - {D}^{2} + D ) + \\ 6 ( K - 1 ) ( 2 - K ) - {d}_{0}^{2}\end{matrix}}{12 {d}_{ϕ} ( 1 - \vert {d}_{ϕ} \vert ) - {d}_{0}^{2}} \qquad ( Equation 41 )$$

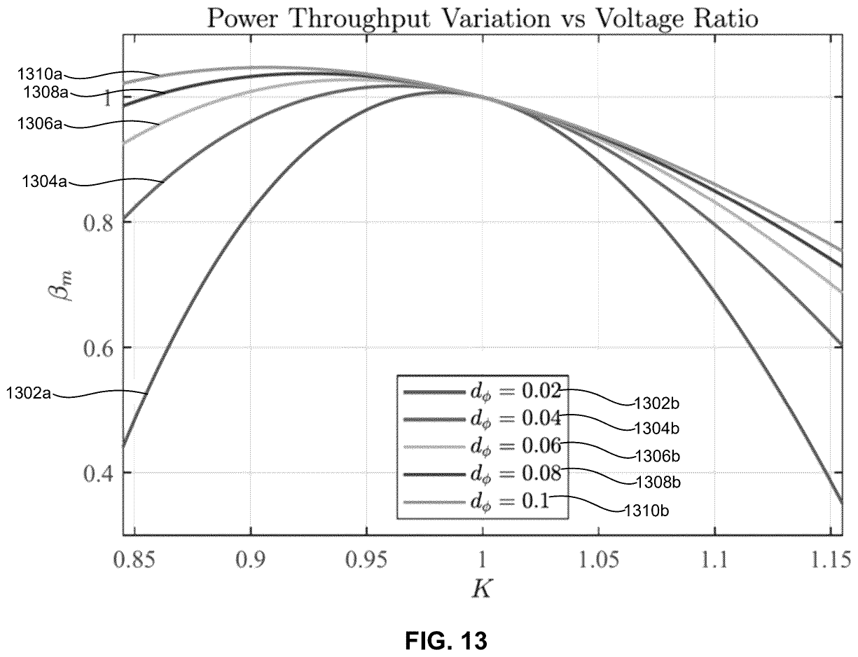

In at least one embodiment, d_{φ} may be limited to about 0.1. Referring now to FIG. 13, shown therein are curves 1302a-1310a showing the change in power throughput caused by variations in K for various operating points for d_{φ} values of 1302b-1310b (up to d_{φ}=0.1). In at least one embodiment, the effective dc link voltage of the first transformer side is equal to the sum of v_{b} and vₚᵥ. Accordingly, the reduction in power throughput caused by dₘ may also be implicit in the plots as the dc link voltage ratio can be directly dependent upon dₘ.

It can be concluded from FIG. 13 that both dₜ and dₘ may need to be minimized to reduce their respective impacts on the power throughput. Additionally, in at least one embodiment, the phase-shift between the two sides of the transformer may not be made excessively large to minimize the current stress on the semiconductor devices as well as the transformer, while mitigating the reactive power losses in the multiport converter 100. The conditions described above may be based on nominal operating conditions of the multiport converter 100, and in at least one embodiment or conditions, it may be necessary to operate outside of the recommendations described herein.

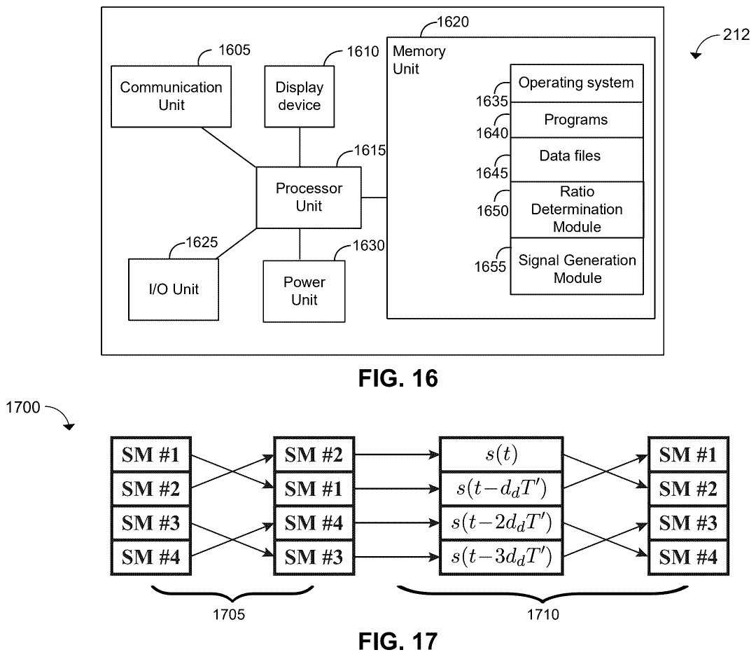

Referring next to FIG. 17, shown therein is a schematic diagram 1700 of an example sorting algorithm used to regulate the submodule capacitor voltages on the second transformer side. The sorting algorithm may be performed, for example, by one or more processors of the control system 212 shown in FIGS. 2 and 16 for controlling transfer of power using MPC 100.

The sequential switching of submodules (e.g., as described herein above with reference to FIG. 7) in the various arms may result in an uneven exchange of energy with each submodule, resulting in the submodule capacitor voltages becoming unbalanced over time. A sorting algorithm may be used to ensure that the submodule capacitor voltages always remain balanced. The sorting algorithm can insert and bypass submodules in a given converter arm based on their capacitor voltages.

As described herein above, a submodule that is inserted in the arm at t=t₀ may be charged/discharged the most during a given switching period. If the submodule with the lowest capacitor voltage is always inserted first, its capacitor voltage may always increase by the maximum amount for that switching period. On the other hand, if the submodule with the highest capacitor voltage is always inserted last, its capacitor voltage may always increase by the least amount during the charge time. Accordingly, the submodule that is inserted first may be charged the most while every subsequently inserted submodule may be charged to a slightly lesser degree.

The schematic diagram 1700 shows a scenario for an example MPC with four submodules per arm and where the submodule capacitor voltages are distributed such that v_{C2}<v_{C1}<v_{C4}<v_{C3} (the subscript of the capacitor voltage may correspond to the submodule in question, for example, v_{C2} may be used to denote the submodule capacitor voltage of SM #2). As denoted by 1705, the submodules may be first sorted in ascending order according to their voltages. The switching pulses that are applied to the submodules may be denoted by s(t−mT′), where m=0, 1, 2, 3 depending on the desired delay required to achieve Q2L operation. SM #2 has the lowest voltage. Accordingly, the switching pulse s(t) may be applied to SM #2 and SM #2 may be the first submodule to be inserted into the arm. For the illustrated example, the capacitor voltage of SM #1 is the second lowest. Accordingly, the switching pulse s(t−d_{d}T′) may be applied to SM #1. This process can continue until all of the submodules have been inserted. Accordingly, the sorting algorithm can enable balanced capacitor voltages.

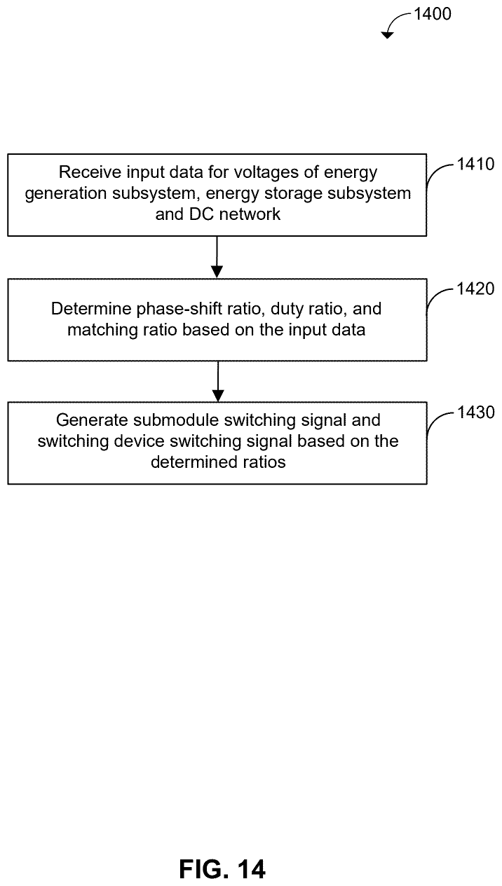

Referring next to FIG. 14, shown therein is a flowchart of an example embodiment of a process 1400 for controlling transfer of power between an energy generation subsystem, an energy storage subsystem and a DC network. Process 1400 may be performed by any combination of hardware-based platforms (i.e., programmed through physical logic gates/devices) and/or software-based platforms (i.e., microcontrollers, digital signal processors, and similar devices) through algorithms that are based on any combination of serial and/or parallel processing techniques. Process 1400 may be performed, for example, by one or more processors of the control system 212 shown in FIG. 2 for controlling transfer of power using MPC 100. An example embodiment of the control system 212 is shown and described with respect to FIG. 16.

Process 1400 may start automatically (e.g., on a periodic basis), manually under a user's command (e.g., provided using an I/O unit of control system 212) and/or when a request for transfer of power is received from a controller of any of the energy generation subsystem, energy storage subsystem and the DC network.

At step 1410, input data for voltages of an energy generation subsystem/device, an energy storage subsystem/device and/or a DC network may be received. For example, control system 212 may receive the input data for voltages of the energy generation subsystem, the energy storage subsystem and/or the DC network. The input data may be provided by voltage sensors connected to the energy generation subsystem, energy storage subsystem and/or DC network.

In at least one embodiment, a mode of operation for MPC 100 may be determined based on the received input data. In at least one embodiment, further input data (e.g., from an operator of the DC network, the energy generation subsystem, the energy storage subsystem, MPC 100 or a combination thereof) specifying the mode of operation for MPC 100 may be received at step 1410. In some cases, the modes of operation may depend on ambient conditions (i.e., the amount of power generated by the energy generation device), demands of the DC grid/network, and/or state of the energy storage device.

At step 1420, a phase-shift ratio, a duty ratio, and/or a matching ratio based on the received input data and/or the mode of operation may be determined. For example, control system 212 may determine the phase-shift ratio, duty ratio, matching ratio or a combination thereof based on the received input data and/or the mode of operation. The phase-shift ratio may be determined based on the input voltage data received at step 1410 and using Equation 34 described herein above for the required power throughput. The duty ratio and the matching ratio may be determined as described with reference to FIG. 11B. The phase-shift ratio, the duty ratio, and the matching ratio may be implemented in a closed-loop control system, for example, a closed-loop control system implemented by control system 212.

The phase-shift ratio, the duty ratio, the matching ratio or any combination thereof may be used to control the mode of operation for MPC 100 and impact the transfer of power as described herein with reference to FIGS. 11 to 13. For example, control system 212 may control the phase-shift ratio between a submodule switching signal (provided to submodules in arms 230, 232, 234 and 236 of MPC 100) and a switching device switching signal (provided to switching devices 220, 222, 224 and 226 of MPC 100). The phase-shift ratio can control the direction of power transfer between the first transformer side and the second transformer side. Some examples are provided below.

As a second example, control system 212 may control the duty ratio of sets of switching pulses provided to switching devices 220 and 224 of MPC 100 to control a terminal voltage of an energy generation subsystem coupled to MPC 100 for implementing a maximum-power-point-tracking (MPPT) algorithm.

As a third example, control system 212 may implement a VMS by controlling a matching ratio between a first set of switching pulses (provided to first arm 230 and fourth arm 236 of MPC 100) and a second set of switching pulses (provided to second arm 232 and third arm 234 of MPC 100).

At step 1430, a submodule switching signal and switching device switching signal may be generated based on the determined ratios. For example, control system 212 may generate the submodule switching signal and switching device switching signal based on the ratios determined at step 1420. Control system 212 may provide the generated submodule switching signals to submodules in arms 230, 232, 234 and 236 of MPC 100 and provide the generated switching device switching signals to switching devices 220, 222, 224 and 226 of MPC 100. For example, based on the determined ratios, control system 212 may use an internal clock/timer to determine corresponding on/off time for the switching pulses of the submodule switching signal and switching device switching signal. The generated signals may be provided to the corresponding MPC components via the I/O pins/ports of the control system 212.

As a first example of the implementation of process 1400, assuming that the voltage input data received at 1410 indicates that the energy generation device generates the expected rated power and the energy storage device is fully charged. Assuming that the overall system is designed such that no voltage matching on the second transformer side and no variations in the duty ratio on the first transformer side are required for this condition. At 1420, both dₘ and dₜ may be determined to be zero and at 1430, the correspond switching signals may be generated. In this first example, the power generated by the energy generation device may be transferred to the DC network with both the vₚ and vₛ waveforms being two-level waveforms.

As a second example of the implementation of process 1400, assuming that the voltage input data received at 1410 indicates that the power generated by the energy generation device has dropped to half of that in the first example (i.e., half the rated power). This implies a shift in the operating point for MPPT resulting in a different target voltage for v*ₚᵥ. At 1420, a new duty ratio can be determined based on the change in target for v*ₚᵥ (and assuming that v_{b} and V_{dc2} remained unchanged). At 1430, the corresponding switching signals can be generated. Furthermore, the new v*ₚᵥ implies a change in V_{dc1}. When new voltage input data at 1410 indicates the change, a new dₜ may be determined at 1420 to implement VMS. At 1430, the corresponding switching signals can be generated. Additionally, the changes in the duty ratio and dₜ can reduce the power throughput of the converter. When new voltage input data at 1410 indicates the change, a new phase shift ratio may be determined at 1420 and corresponding switching signals may be generated at 1430.

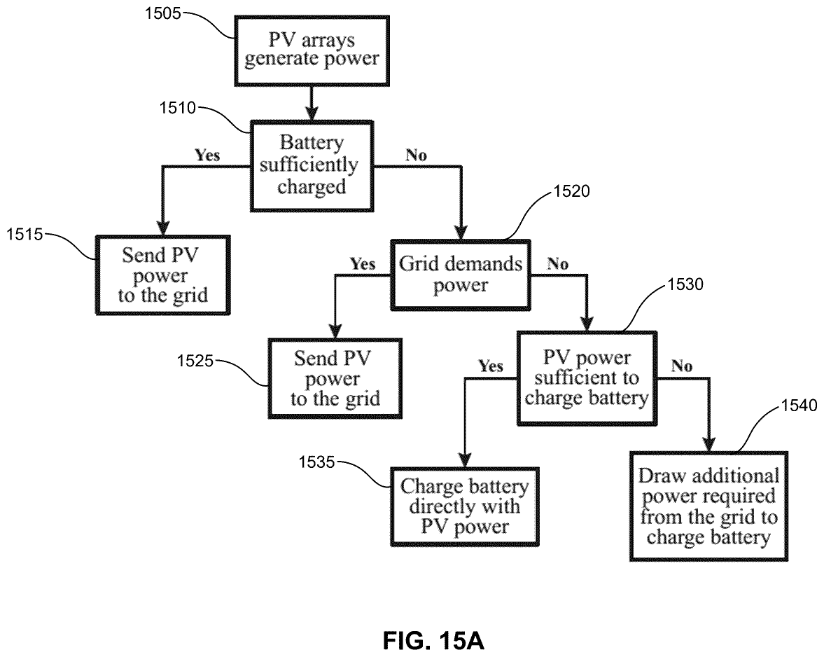

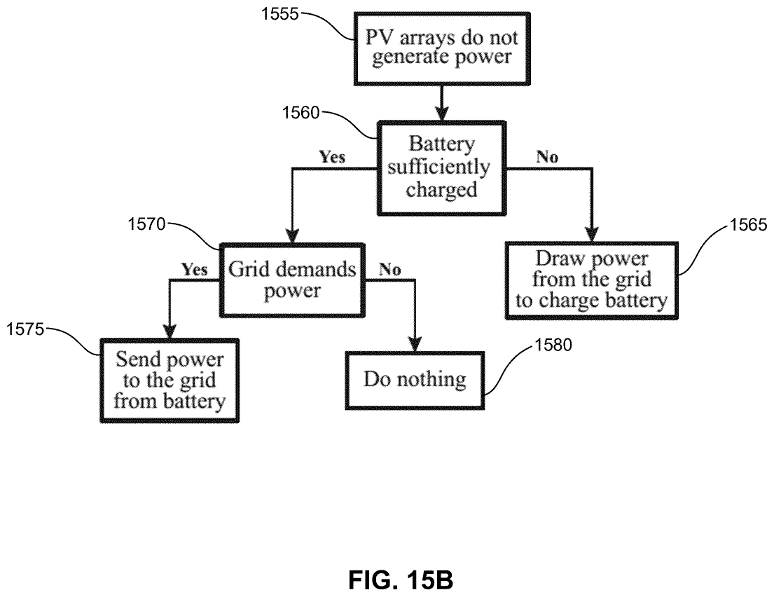

Reference is next made to FIGS. 15A and 15B. FIG. 15A shows a flow diagram representation of example modes of operation of a DC-DC multiport converter (e.g., MPC 100) when the energy generation subsystem connected to the MPC is generating power. FIG. 15B shows a flow diagram representation of example modes of operation of a DC-DC multiport converter (e.g., MPC 100) when the energy generation subsystem connected to the MPC is not generating power.

The modes of operation may be controlled, for example, by control system 212 using process 1400, as described herein above. For the examples illustrated in FIGS. 15A and 15B, the energy generation subsystem connected to the MPC includes PV arrays, the energy storage subsystem connected to the MPC includes a battery, and the second transformer side is connected to a power grid. In some embodiments the power grid is a DC power grid. In some embodiments, the power grid is an AC grid that is connected to the second transformer side via an inverter.

The mode of operation may depend on whether the PV arrays are generating power (1505) or not generating power (1555). Referring to FIG. 15A, if the PV arrays are generating power (1505), the mode of operation may next depend on whether the battery is sufficiently charged (1510). If the battery is sufficiently charged, the generated PV power may be provided to the grid (1515). If the battery is not sufficiently charged, the mode of operation may depend on whether there is a power demand from the grid (1520). If there is a power demand from the grid, the generated PV power may be provided to the grid (1525). If there is no power demand from the grid, the mode of operation may depend on whether there is sufficient PV power to charge the battery (1530). If there is sufficient PV power to charge the battery, the battery may be charged with the PV power (1535). If there is insufficient power to charge the battery, additional power may be drawn from the grid to charge the battery (1540).

Referring to FIG. 15B, if the PV arrays are not generating power (1555), the mode of operation may next depend on whether the battery is sufficiently charged (1560). If the battery is not sufficiently charged, power may be drawn from the grid to charge the battery (1565). If the battery is sufficiently charged, the mode of operation may depend on whether there is a power demand from the grid (1570). If there is a power demand from the grid, power may be provided from the battery to the grid (1575). If there is no power demand from the grid, no power transfer may be performed.

The modes of operation may be classified based on whether power generated by the PV arrays can be extracted at the maximum-power-point. The ability of the DC-DC multiport converter 100 to extract PV power at the maximum-power-point may depend directly on the battery voltage. The two primary modes of operation may therefore depend on the state of charge of the battery.

In Mode I (MPPT mode), the maximum power that is available from the PV arrays may be extracted using MPPT by controlling the duty cycle of the first transformer side using the duty ratio dₘ of the first transformer side. The requirements for mode I may be that the battery is sufficiently charged to sustain the required voltage vₚᵥ to achieve MPPT and that the PV arrays are generating power. A control algorithm (e.g., implemented by software program instructions and executed by control system 212) may be used to select operation of the converter in mode I based on input voltage data of the PV arrays, the battery and the grid. After the control algorithm establishes that the converter should operate in Mode I, the duty ratio dₘ may be calculated as described herein above with reference to process 1400. If the power generated by the PV arrays is greater than the demand of the grid, the excess power may be used to charge the battery. Alternatively, if the power generated by the PV arrays cannot meet the demand of the grid, the deficit of power may be compensated by the battery. After the battery surpasses its maximum discharging capacity, the multiport converter 100 may be forced to shut down. Alternatively, if the battery current exceeds its maximum discharging current limit, the system may move into a non-MPPT mode of operation.

In Mode II (non-MPPT mode), the power balancing may be carried out by reducing the power extracted from the PV arrays to a value such that the battery is not overcharged. On the typical PV characteristic, there can be two potential operating points where this power condition may be met. Of the two potential operating points, the one with a higher voltage may be more desirable as it may be more stable due to increased solar power with reduction in PV voltage. In this mode, the power extracted from the PV arrays may be controlled through the duty ratio dₘ of the first transformer side, while the power delivered to the load may be controlled through the phase-shift ratio d_{φ}.

The requirements for mode II may be that the battery is not able to provide the PV arrays with the voltage required to achieve MPPT and that the PV arrays are generating power. In mode II, the charging of the battery may take priority (unless specific conditions require grid priority) because the converter is not able to achieve MPPT. The amount of power that is transferred from the first transformer side to the second transformer side may be directly controlled by the phase-shift ratio (as described by Equation 34). Any excess power that is not transferred to the second transformer side can automatically charge the battery (based on the topology of the converter). A control algorithm may be used to prevent overcharging of the battery based on previously provided data related to the overcharging limit of the battery. The control algorithm can control the phase-shift ratio such that the power transferred to the second transformer side enables the battery to be safely charged by the excess PV power.

Referring now to FIG. 16, shown therein is a schematic diagram illustrating an example embodiment of the hardware structure of a control system 212 that may be used with an embodiment of the DC-DC multiport converter described herein. In the example illustrated, the control system 212 includes a communication unit 1605, a display device 1610 (which may be optional in some cases), a processor unit 1615, a memory unit 1620, an I/O unit 1625, and a power unit 1630. The control system 212 may be implemented using a desktop computer, a laptop, a tablet, a digital signal processor, a field-programmable gate-array (FPGA) based platform, a programmable logic device (PLD) or another suitable computing device.

Communication unit 1605 may include wired or wireless connection capabilities. For example, communication unit 1605 can include a radio that communicates utilizing CDMA, GSM, or GPRS protocol according to standards such as IEEE 802.11a, 802.11b, 802.11g, or 802.11n or another suitable protocol. Alternatively, or in addition thereto, communication unit 1605 may be a standard network adapter such as an Ethernet or 802.11x adapter or another type of adapter. Accordingly, communication unit 1605 can also include at least one of an Internet connection, a Local Area Network (LAN) connection, an Ethernet connection, a FireWire connection, a modem connection, or a digital subscriber line connection.

Communication unit 1605 may to allow control system 212 to communicate with other devices or computers. For example, control system 212 may use communication unit 1605 to receive, via a communication network, input data for voltages of one or more energy generation devices of the energy generation subsystem, one or more energy storage devices of the energy storage subsystem, the DC network or any combination thereof. In at least one embodiment, control system 212 may also use communication unit 1605 to receive input data specifying the mode of operation for MPC 100.

Processor unit 1615 is configured to control the operation of control system 212. Processor unit 1615 may include any suitable processor or controller that can provide sufficient processing power depending on the configuration, purposes and requirements of control system 212 as is known by those skilled in the art. For example, processor unit 1615 may include a standard processor, such as an Intel or AMD processor, a high-performance Central processing unit (CPU), a Graphics Processing unit (GPU) or combinations thereof. Accordingly, in some cases, processor unit 1615 may include more than one processor with each processor being configured to perform different dedicated tasks. Accordingly, processor unit 1615 may be considered as having at least one processor. Alternatively, specialized hardware may be used provide some of the functions provided by processor unit 1615.

Display device 1610 may be a LED or LCD based display and may be a touch sensitive user input device that receives inputs from user contact such as user gestures on the touch sensitive surface of the display device 1610. The display device 1610 may be integrated into control system 212. In at least one embodiment, display device 1610 may be located physically remote from control system 212 and communicate with control system 212 using a communication network. Display device 1610 may provide notifications and display analysis results to a user of control system 212. In some cases, display unit 1610 may be optional.

I/O unit 1625 may include at least one input device and/or at least one output device. For example, the input device may include a mouse, a keyboard, a touch screen, a thumbwheel, a trackpad, a trackball, a card-reader, voice recognition software and the like, depending on the particular implementation of control system 212. The output device may include a speaker, a printer, a scanner and the like. In at least one embodiment, some of these components may be integrated with one another.

I/O unit 1625 also includes at least one data communication port like one or more serial ports, one or more parallel ports, one or more USB ports that provides USB connectivity or any combination thereof. The data communication port may be used to receive sensor values from one or more sensors that may be used to provide measurement data of voltages and/or currents from energy generation subsystem, energy storage subsystem, a power grid or a combination thereof. The data communication port may also be used to provide control values to the multiport converter described in accordance with the teachings herein.

I/O unit 1625 may also include general-purpose input/output (GPIO) capabilities in order to facilitate additional functionality. For example, I/O unit 1625 is generally configured to have one or more digital input pins/ports to receive digital inputs to detect faults and/or receive fault notifications. I/O unit 1625 is generally configured to have one or more digital output pins/ports to provide digital outputs to provide the switching pulses and/or switching signals to the switching devices and/or submodules. I/O unit 1625 is also generally configured to have one or more analog input pins/ports to receive input data for voltages and/or currents of different components of the converter and any peripheral devices.

Power unit 1630 may be any suitable power source that provides power to various components of control system 212 such as a power adaptor or a rechargeable battery pack depending on the implementation of control system 212, as is known by those skilled in the art. In some cases, power supply unit 1630 may include a surge protector that is connected to a mains power line and a power converter that is connected to the surge protector (both not shown). The surge protector protects the power supply unit 1630 from any voltage or current spikes in the main power line and the power converter converts the power to a lower level that is suitable for use by the various elements of control system 212. In other embodiments, power supply unit 1630 may include other components for providing power or backup power as is known by those skilled in the art.

Memory unit 1620 includes volatile and non-volatile storage such as RAM, ROM, one or more hard drives, one or more flash drives or some other suitable data storage elements. The non-volatile storage may be used to store software instructions, including computer-executable instructions, for implementing operating system 1635, programs 1640, data files 1645, ratio determination module 1650 and signal generation module 1655. For instance, operating system 1635 and programs 1640 may provide various basic operational processes for control system 212. Operating system 1635 may, for example, be an operating system such as Windows® Server operating system, or Red Hat® Enterprise Linux (RHEL) operating system, or other suitable operating systems known by those skilled in the art. The software code may be executed, for example, by processor unit 1615 of control system 212.

Data may be stored in data files 1645 for operating parameter values for the multiport converter. The parameter values may include values for parameters used in some of the equations described herein, as well as threshold values, and valid operating ranges for parameters. Input data for measured voltages and/or current of energy generation subsystem, energy storage subsystem, DC network, other power grid or any combination may be stored in data files 1645. Data files 1645 may also store the determined phase-shift ratio, duty ratio, matching ratio or any combination thereof.

In at least one embodiment, control algorithms may be executed by the control system 212 to perform closed-loop control functions and data related to multiple iterations of the control computations may be stored in data files 1645. Historical data related to power generation performance of any power generation devices may also be stored in data files 1645. In some embodiments, historical performance data of different components of the MPC, diagnostic testing data, timestamped event data, error codes, and test algorithms for start-up, operation monitoring, self-testing may be stored in data files 1645.

In at least one embodiment, a one or more databases may also be used for storing data. The databases may include a Structured Query Language (SQL) database such as PostgreSQL or MySQL or a not only SQL (NoSQL) database such as MongoDB, or Graph Databases, etc.

Ratio determination module 1650 includes program instructions, which when executed by processor unit 1615, configure the processor unit 1615 to determine the phase-shift ratio, the duty ratio, the matching ratio or any combination thereof based on the received input data and/or the mode of operation, as described herein above with references to FIGS. 14, 15A and 15B.

Signal generation module 1655 includes program instructions, which when executed by processor unit 1615, configure the processor unit 1615 to generate a submodule switching signal and a switching device switching signal, as described herein above with reference to FIGS. 14, 15A and 15B, based on the ratios determined by ratio determination module 1650. These signals may be sent to the multiport convertor through I/O unit 1625 and/or communication unit 1605.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

1. A DC-DC multiport converter (MPC) for transfer of power between an energy generation subsystem, an energy storage subsystem and a DC network, wherein the MPC comprises:
a multi-winding transformer having a first transformer side and a second transformer side, wherein:
a DC link of the first transformer side is coupled with the energy generation subsystem and the energy storage subsystem; and
a DC link of the second transformer side is coupled to the DC network;
a first MPC circuit branch and a second MPC circuit branch connected in parallel on the first transformer side to couple the DC link of the first transformer side with the energy generation subsystem and the energy storage subsystem, each of the first MPC circuit branch and the second MPC circuit branch having at least a pair of companion switching devices; and
a third MPC circuit branch and a fourth MPC circuit branch connected in parallel on the second transformer side to connect the DC link of the second transformer side with the DC network, each of the third MPC circuit branch and the fourth MPC circuit branch having multiple series-connected submodules,
wherein the transfer of power is controlled when each of the submodules receive a submodule switching signal and each of the switching devices receive a switching device switching signal.

2. The MPC of claim 1, wherein a direction of power transfer between the first transformer side and the second transformer side is controlled by controlling a phase-shift ratio between the submodule switching signal and the switching device switching signal.

3. The MPC of claim 1, wherein the first MPC circuit branch includes a first switching device and a second switching device; the second MPC circuit branch includes a third switching device and a fourth switching device; and
the switching device switching signal includes a first set of switching pulses to control switching of the first switching device, a second set of switching pulses to control switching of the second switching device, a third set of switching pulses to control switching of the third switching device, and a fourth set of switching pulses to control switching of the fourth switching device, wherein the second set of switching pulses are coordinated with the first set of switching pulses and the fourth set of switching pulses are coordinated with the third set of switching pulses.

4. The MPC of claim 3, wherein a duty ratio of the first set of switching pulses and the third set of switching pulses is selected to control a terminal voltage of the energy generation subsystem for implementing a maximum-power-point-tracking (MPPT) algorithm.

5. The MPC of claim 1, wherein the third MPC circuit branch includes a first arm and a second arm; the fourth MPC circuit branch includes a third arm and a fourth arm, wherein each of the first arm, the second arm, the third arm and the fourth arm includes multiple series-connected submodules; and
the submodule switching signal includes a first set of switching pulses to control diagonally pairwise switching of the multiple series-connected submodules in the first arm and the fourth arm, and a second set of switching pulses to control diagonally pairwise switching of the multiple series-connected submodules in the second arm and the third arm.

6. The MPC of claim 5, wherein the multiple series-connected submodules in the first arm are switched by the first set of switching pulses in a coordinated sequence to generate a stepped trapezoidal arm voltage of the first arm.

7. The MPC of claim 5, wherein a second transformer side voltage is controlled by controlling a matching ratio between the first set of switching pulses and the second set of switching pulses.

8. The MPC of claim 1, wherein each of the switching devices include one or more semiconductor switching devices.

9. The MPC of claim 1, wherein at least one of the series connected submodules includes a half-bridge submodule topology, a full-bridge submodule topology, a clamp-double submodule topology, a three-level flying-capacitor (FC) submodule topology, a three-level neutral-point-clamped (NPC) submodule topology, or a five-level cross-connected submodule topology.

10. The MPC of claim 1, wherein the energy generation subsystem includes one or more photovoltaic (PV) arrays.

11. The MPC of claim 1, wherein the energy storage subsystem includes one or more batteries.

12. The MPC of claim 1, wherein the first transformer side is configured to operate in a low voltage range from about 0V to about 1.5 kV.

13. The MPC of claim 1, wherein the second transformer side is configured to operate in a medium voltage range from about 1.5 kV to about 30 kV.

14. The MPC of claim 1, wherein the center-tapped transformer side is configured to operate in a medium frequency range from about 1 kHz to about 100 kHz.

15. The MPC of claim 1, wherein the multi-winding transformer is a center-tapped transformer and a center-tap of the first transformer side is configured to be connected to a junction between the energy generation subsystem and the energy storage subsystem.

16. A DC-DC multiport converter (MPC) for transfer of power between an energy generation subsystem, an energy storage subsystem and a DC network, wherein the MPC comprises:
a multi-winding transformer having a first transformer side and a second transformer side, wherein:
a DC link of the first transformer side is coupled with the energy generation subsystem and the energy storage subsystem; and
a DC link of the second transformer side is coupled to the DC network;
a first MPC circuit branch and a second MPC circuit branch connected in parallel on the first transformer side to couple the DC link of the first transformer side with the energy generation subsystem and the energy storage subsystem, each of the first MPC circuit branch and the second MPC circuit branch having at least a pair of companion switching devices;
a third MPC circuit branch and a fourth MPC circuit branch connected in parallel on the second transformer side to connect the DC link of the second transformer side with the DC network, each of the third MPC circuit branch and the fourth MPC circuit branch having multiple series-connected submodules; and
a control system configured to control the transfer of power by providing a submodule switching signal to each of the submodules and a switching device switching signal to each of the switching devices.

17. The MPC of claim 16, wherein the control system is further configured to control a direction of power transfer between the first transformer side and the second transformer side by controlling a phase-shift ratio between the submodule switching signal and the switching device switching signal.

18. The MPC of claim 16, wherein the control system is further configured to control a duty ratio of the first set of switching pulses and the third set of switching pulses to control a terminal voltage of the energy generation subsystem for implementing a maximum-power-point-tracking (MPPT) algorithm.

19. The MPC of claim 16, wherein the control system is further configured to control a second transformer side voltage by controlling a matching ratio between the first set of switching pulses and the second set of switching pulses.

20. The MPC of claim 16, wherein the multi-winding transformer is a center-tapped transformer and a center-tap of the first transformer side is configured to be connected to a junction between the energy generation subsystem and the energy storage subsystem.
